(19) United States
(12) Patent Application Publication
(10) Pub. No.: US 2001/0054002 A1
(43) Pub. Date: Dec. 20, 2001

(54) Campaign system

(76) Inventors: Tatsuo Suzuki, Urayasu (JP); Kazuyoshi Iyogi, Bunkyo (JP)

Correspondence Address: STAAS & HALSEY LLP, 700 11TH STREET, NW, SUITE 500, WASHINGTON, DC, 20001, US

(21) Appl. No.: 09/814,756

(22) Filed: Mar. 23, 2001

(30) Foreign Application Priority Data
Jun. 12, 2000 (JP) 2000-175304

(51) Int. Cl. G06F 17/60

(52) U.S. Cl. 705/14

(57) ABSTRACT

A campaign system is composed of a campaign execution apparatus, POS systems, and portable telephones, all of which can use the Internet to communicate with one another. When there arises the campaign registration, the campaign execution apparatus in which member information including preference information has been accumulated extracts registered members that become to be targets of the campaign from the member information. The registered member receives campaign mail that fits his or her interest, and then he or she inputs identification information displayed as a bar code on the display of the portable telephone into the POS system. Then, a relier of the campaign can acquire private information that were not able to be acquired only with the POS system.

### BACKGROUND OF THE INVENTION

1. Field of the Invention

The present invention relates to a campaign system that distributes information concerning commodities that fit interest of a customer who uses a portable information terminal and that acquires identification information of the customer together with information of a commodity which the customer purchases from the above-mentioned portable information terminal through a POS terminal installed at a cashier counter of a store.

2. Description of a Related Art

In general POS systems, commodity (or service) information inputted into the POS terminal installed at the cashier counter of a store is notified to a host computer, whereby the commodity information is accumulated in a commodity database in the host computer. Based on the commodity information accumulated in the commodity database, a manager operating the host computer sets prices of the commodities that will be sold at a storefront, checks inventory state of the commodities, totals up sales of the commodities, and organizes a plan of buying the commodities.

Conventionally, in such POS systems, information concerning a customer who purchases the commodity may be inputted into the POS terminal together with the commodity information, with the intention of making the use of such information for sales promotion at storefront, for determination of buying of the commodities, or for adjustment of manufacturing of the commodities. Concretely, a cashier of the store judges customer's sex, age group, etc. according to his/her appearance and inputs these pieces of customer information into the POS terminal just before reading a bar code (indicating the commodity information of the commodity, such as a kind, a price, etc. thereof) printed on the commodity that the user purchases. By this method, consumer information concerning a customer who purchased the commodity is recorded together with the commodity information, so that a buyer of the store can adjust the amount of commodities to buy or to manufacture to adapt the clientele of the store, by analyzing the commodity information and the consumer information.

However, since acquisition of the consumer information with the conventional POS system is, as described above, performed by the cashier of a store judging user's sex, age group, etc. on the basis of user's appearance and inputting these into the POS terminal, acquired consumer information is pretty incorrect. Moreover, since the acquired consumer information is limited to sex, age group, or so, it is impossible to acquire detailed private information concerning the customer. Therefore, it is hardly possible to narrow down target customers when a campaign for sales promotion is to be held and to specify potential customers who has purchased the commodities at the store front by then to send them direct mails etc. As a result, it is possible only to promote a campaign where many and unspecified customers are targeted, so that an effect of the campaign has not been achieved easily.

On the other hand, since the Internet expands so rapidly due to recent improvement of communication technologies, a dealer can open a virtual store on the Internet at the expense of low cost and readily. Thus, by exhibiting commodities the dealer deals with in the virtual store on the Internet, the dealer can sell his or her commodities to more users, and by conducting a simple questionnaire to the customer purchasing the commodity, the dealer can acquire and accumulate customer's preference information indicating fields in which the customer is interested, which enables sales promotion thereafter.

However, in the virtual store on the Internet, it is difficult to deal with such commodities that the customers likely hesitate to purchase at a mere sight thereof on the screen, for example, foods such as vegetables and juices, and commodities that are required to fit customer s body such as clothes and eye glasses. For these commodities, it is realistic for customers to come to the storefront, to see and touch the commodities, and then to purchase them. Although it may be probable to impel the customers in the virtual store on the Internet to come to a real store, it is not easy to increase the number of the customers that come to the real store actually. Therefore, there is needed a method for selling commodities in the real store with merits of selling in the virtual store on the Internet.

### SUMMARY OF THE INVENTION

The present invention has been devised in the light of issues of the conventional technology described above. It is the primary object of the present invention to provide a campaign system that can directly prompt the user having the portable information terminal to come actually to the store where an information input terminal such as the POS system has been installed and that can correctly accumulate the customer's private information and the customer s preference together with the commodity information of a commodity the customer purchased.

A campaign system according to the present invention that is constituted to achieve the above-mentioned problem. In the campaign system, e-mail that contains first identification information corresponding to a previously-registered member and second identification information assigned to a specific campaign is sent from a campaign execution apparatus to the portable information terminal of the member and a user of the said portable information terminal is confirmed to be entitled to the campaign by a process where the identification information displayed on the portable information terminal having received this e-mail is inputted into an information input device. The campaign execution apparatus has a first storage that stores the first identification information and destination information concerning a plurality of members, a second storage that stores the second identification information assigned to any one of the campaigns, an e-mail generation part for generating the above-mentioned e-mail containing the first identification information and the second identification information that were extracted from the first storage and the second storage, respectively, according to predetermined conditions, and an e-mail sending part for sending this e-mail generated by the e-mail generation part to a destination indicated by the destination information corresponding to the first identification information that is contained in the e-mail. The portable information terminal has an e-mail receiving part for receiving e-mail and a display panel for displaying the both pieces of identification information that are contained in the e-mail received by the e-mail receiving part. The information input device comprises an input part into which the both pieces of identification information are inputted.

The campaign execution apparatus according to the present invention sends e-mail containing the first identification information corresponding to the previously-registered members and the second identification information assigned to a specific campaign to the portable information terminal of the member. The campaign execution apparatus has a first storage that stores the first information and destination information concerning a plurality of members, a second storage that stores the second identification information assigned to any one of the campaigns, an e-mail generation part for generating e-mail containing the first identification information and the second identification information that were extracted from the first storage and the second storages respectively, according to predetermined conditions, and an e-mail sending part for sending the e-mail generated by the e-mail generation part to a destination indicated by the destination information corresponding to the first identification information that is contained in the email.

A computer-readable medium according to the present invention stores a program. The program runs on a computer equipped with a communication device, whereby the computer can establish connection with a network connected to portable information terminals. The program makes the computer generate the first storage that stores first identification information and the destination information concerning a plurality of members and second identification information assigned to any one of the campaigns, extract the first identification information and the destination information from the first storage according to predetermined conditions, extract the second identification information from the second storage part according to predetermined conditions, generate e-mail containing these first identification information and second identification information, and send the e-mail to a destination indicated by the destination information via the communication device.

The method of promoting a campaign according to the present invention is to realize a campaign in which a previously-registered user of a portable information terminal is confirmed to be entitled to a specific campaign by a process where e-mail containing the first identification information corresponding to the member and the second identification information assigned to a specific campaign is sent from the campaign execution apparatus to the portable information terminal of the member and the identification information that is displayed in the portable information terminal having received this e-mail is inputted into the information input apparatus. In the method, campaign execution apparatus stores the first identification information and the destination information concerning a plurality of members as well as the second identification information assigned to any one of the campaigns, generates the e-mail containing the first identification information and the second identification information that were extracted according to predetermined conditions, sends the e-mail to the destination indicated by the destination information corresponding to the first identification information contained in the e-mail. When the portable information terminal receives the e-mail containing the first identification information and the second identification information, it displays the both pieces of the identification information contained in the e-mail on the display thereof.

With such a configuration as described above, the campaign execution apparatus sends the e-mail that was generated so as to contain the first and second identification information each of which was extracted, respectively, according to predetermined conditions to the destination indicated by the destination information corresponding to the first identification information. In the portable information terminal having received this e-mail, the first and second identification information are displayed, as they are, or in a state that both pieces of information are combined together according to a predetermined logic, on the display panel thereof. Moreover, into the information input device, the first and second identification information displayed on the display panel of the portable information terminal are inputted through its input part. As a result, the identification information of the registered members that have been entitled to the campaign is accumulated in the information input device.

According to the present invention, since e-mail sent to the portable information terminal can be added with description of phrases for doing direct publicity to the user of the portable information terminal and privileged service information, it is possible to impel the user of the potable information terminal to actually come to the storefront of a store where the information input device is installed. Moreover, since the identification information of the registered members is accumulated in the information input device such as the POS system, when a campaign for sales promotion etc. is conducted, the target user of the campaign can be narrowed down by using the information so accumulated.

In the campaign system according to the present invention, the first and second identification information may be displayed, on the display panel of the portable information terminal, as they are, or as a combination of both pieces of identification information that is formed according to a predetermined logic. The identification information may be displayed as in a digitized form thereof, or may be displayed as in the form of the bar code. In the case where the identification information is displayed in the form of the bar code, it is necessary for the information input device to be provided with a bar code reader for reading the bar code indicated on the display panel of the portable information terminal and with a decoder for restoring the identification information based on the data obtained by the bar code reader reading the bar code.

### BRIEF DESCRIPTION OF THE DRAWINGS

The invention will be described bellow in detail with reference to the accompanying drawings, in which:

FIG. 1 is a schematic diagram showing a configuration of the network to which a campaign system that is one embodiment of the present invention is applied;

FIG. 2 is a block diagram showing internal structures of devices that constitute the POS system included in the campaign system according to the embodiment;

FIG. 3 is a block diagram showing an internal structure of a portable telephone included in the campaign system according to the embodiment;

FIG. 4 is a view showing a member recruitment screen displayed on a display panel of the portable telephone;

FIG. 5 is a view showing a member registration screen displayed on the display panel of the portable telephone;

FIG. 6 is a view showing the member registration screen displayed on a display of a common computer;

FIG. 7 is a flowchart indicating member information registration processing executed in the campaign execution apparatus;

FIG. 8 is a view showing a data structure of a member information database stored in the campaign execution apparatus;

FIG. 9 is a view showing a data structure of a model name database stored in the campaign execution apparatus;

FIG. 10 is a flowchart indicating e-mail reception processing executed in the portable telephone;

FIG. 11 is a sequence diagram showing an operation procedure of the campaign execution apparatus and a POS host device at the time of campaign registration;

FIG. 12 is a view showing a login screen displayed on the display of the POS host device;

FIG. 13 is an illustrative diagram showing an extraction condition input screen displayed on a display of the POS host device;

FIG. 14 is a view showing the registration screen displayed on the display of the POS host device;

FIG. 15 is a view showing the data structure of a campaign information database stored in the campaign execution apparatus;

FIG. 16 is a flowchart indicating campaign mail sending processing executed in the campaign execution apparatus;

FIG. 17 is a flowchart indicating a subroutine for member information addition processing executed at step S408 of FIG. 16;

FIG. 18 is a view showing the data structure of a mail sending information database stored in the campaign execution apparatus;

FIG. 19 is a view showing the data structure of a user information database that is created in the campaign execution apparatus;

FIG. 20 is a view showing an example of a contents of the campaign mail generated in the campaign execution apparatus;

FIG. 21 is a view showing an example of a display of the campaign mail displayed on the display panel of the portable telephone;

FIG. 22 is a flowchart indicating identification information display processing executed in the portable telephone;

FIG. 23 is a view showing an example of identification information displayed on the display of the portable telephone;

FIG. 24 is a flowchart indicating user information storage processing executed in the POS host device;

FIG. 25 is a flowchart indicating a subroutine of user information updating processing executed at step S609 of FIG. 14;

FIG. 26 is a sequence diagram showing an operation procedure of the campaign execution apparatus and the POS host device when the effect of the campaign is to be confirmed;

FIG. 27 is a schematic diagram showing a configuration of the network as another application example of the campaign system; and

FIG. 28 is an explanatory drawing showing relations among several processing in the campaign system.

### DETAILED DESCRIPTION OF THE INVENTION

Hereinafter, embodiments of the campaign system according to the present invention will be described in detail referring to the drawings.

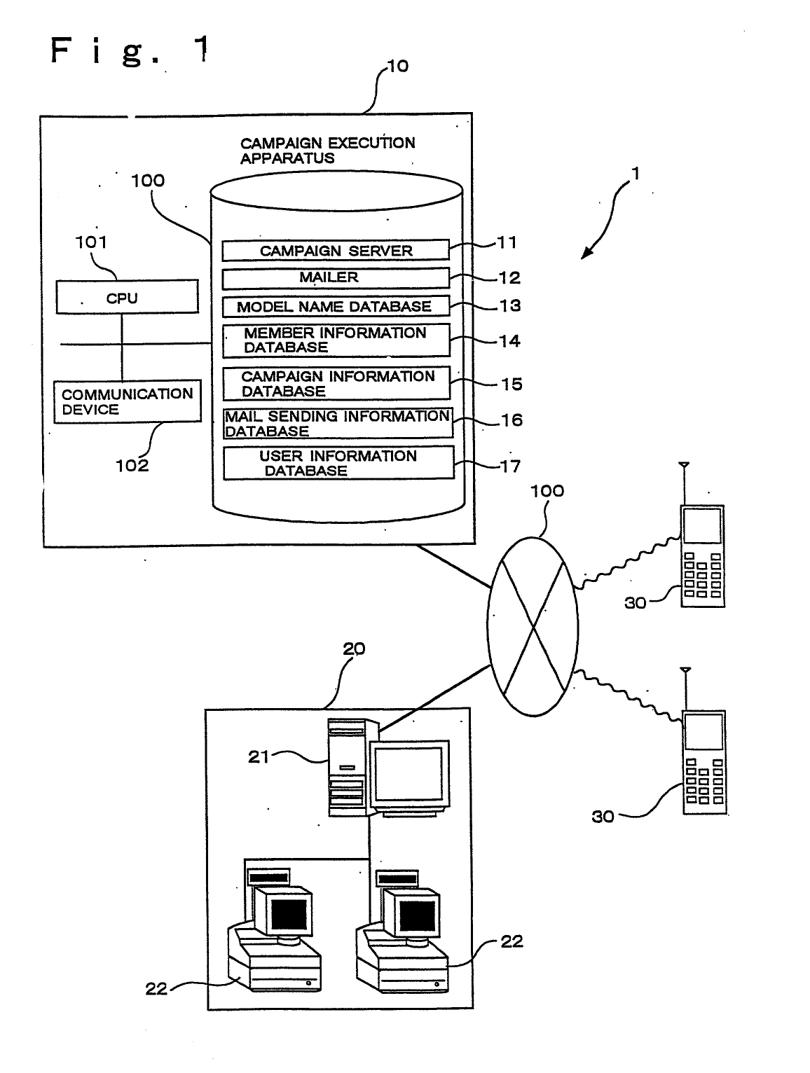

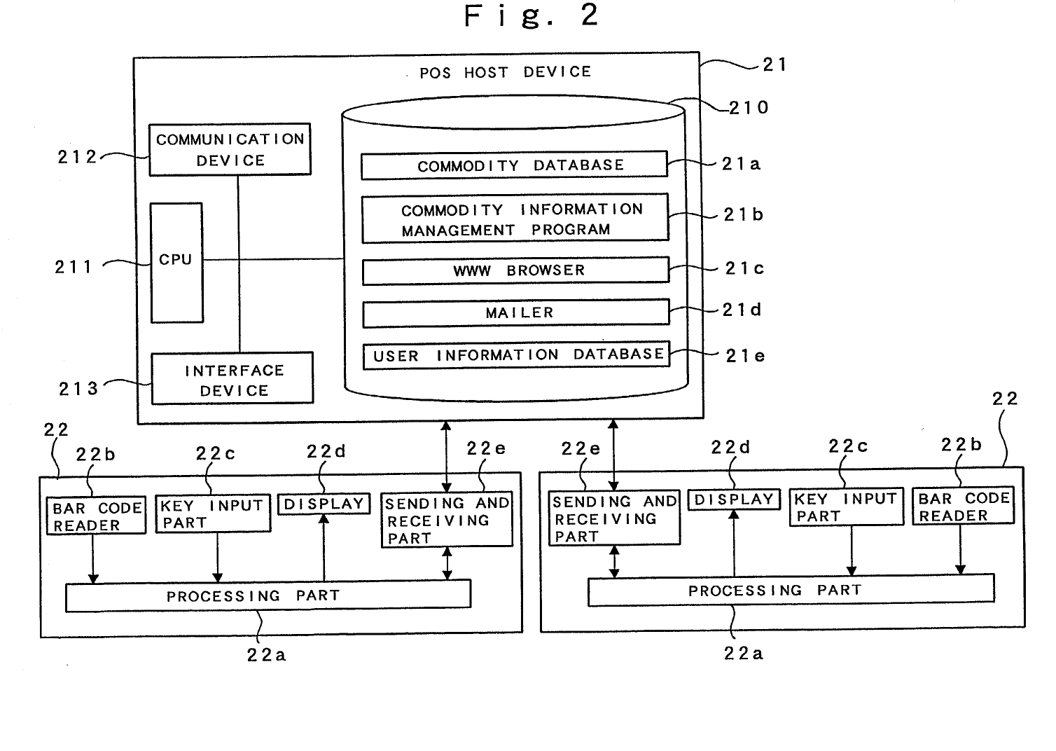

FIG. 1 is the schematic diagram showing a configuration of the network to which a campaign system 1, that is an embodiment of the present invention, is applied. FIG. 2 is a block diagram showing internal structures of the devices that constitute a POS system 20 included in the campaign system 1 of this embodiment. FIG. 3 is a block diagram showing an internal structure of a portable telephone 30 included in the campaign system 1 of this embodiment.

The campaign system 1 includes, as shown in FIG. 1, a campaign execution apparatus 10, a POS system 20, and a number of portable telephones 30 (two telephones 30 are drawn in FIG. 1), all of which are connected to one another via the Internet 100.

The campaign execution apparatus 10 included in the campaign system 1 is a common computer a communication device 102 for communicating with a plurality of terminals such as the POS system 20 and the portable telephones 30, storage medium 100, and a CPU 101. The storage medium 100 stores programs to be executed by a campaign server 11 for making the CPU present a home page consisting of several kinds of Web pages to the terminals in accordance with HTTP, a mailer 12 for enabling the CPU to generate and edit e-mail and to send and receive e-mail to/from a mail server that is located on the Internet 100 but not shown in the figure in accordance with SMTP and POP, a model name database 13, a member information database (serving as the first storage part) 14, a campaign information database (serving as the second storage part) 15, a mail sending information database 16, a user information database (serving as the third storage part) 17, which will be described later.

Note that the campaign server 11 is implemented by the CPU 101 executing a WEB server program and several CGI programs read from the storage medium. These CGI programs include a database program for retrieving and updating the databases 13 through 17 and a program for sending campaign mail to the terminals by using the mailer 12.

The POS system 20 is composed of a plurality of POS terminals 22 installed on the cashier counters in a store where payment for commodities is done and a POS host device 21 connected to these POS terminals 22.

The POS host device 21 that serves as a host computer of this POS system 20 is a common computer having an interface device 213 for receiving data from the POS terminals 22, a communication device (modem, TA, NIC, etc.) for sending and receiving various information to/from the Internet 100, storage medium 210 and a CPU 211. The storage medium 210 stores a commodity database 21a that retains data such as the commodity information, a commodity information management program 21b for making the CPU 211 executes summing of sales of the commodities etc. by using the commodity database 21a, a WWW browser 21c for enabling the CPU 211 to access a WWW server on the Internet 100 (including the campaign server 11 in the campaign execution apparatus 10) to read data such as an HTML file, image data, sound data, a mailer 21d for making the CPU 211 to generate and edit e-mail and to send and receive e-mail to/from the mail server in accordance with SMTP and POP, a user information database (serving as the storage part) 21e, a database program, which will be described later.

The commodity database 21a and the user information database 21e are retrieved or updated by the CPU 211 executing the database program that is read from the storage medium. The commodity information management program 21b has functions of deciding price of the commodities, checking inventory of the commodities, summing of sales of the commodities, planning out purchase of the commodities, etc.

Each of the plurality of POS terminals 22 constituting the POS system 20 has a bar-code reader (serving as the input part) 22b for reading a bar code corresponding to the commodity information such as a kind, a price, etc. of the commodity, a key input part (serving as the input part) 22c for inputting a price etc. of the commodity, a display 22d for displaying the sum of the prices of the commodities, a sending and receiving part 22e for sending and receiving various data to/from the POS host device 21, and a processing part 22a, which are connected to one another. In the case where the POS system 20 is installed over a plurality of stores belonging to the same chain store organization, each of these POS terminals 22 are connected to the POS host device 21, respectively, via dedicated lines.

In this POS system 20, a bar code printed on a commodity is read by the bar-code reader 22b operated by a cashier of the store, whereby the commodity information of the commodity (a kind, a price, etc. of the commodity) is sent to the POS host device 21, so that contents of the commodity information about that commodity retained in the commodity database 21a of the POS host device 21 is properly altered. Moreover, a bar code displayed on a display panel of the portable telephone 30 is read by the bar-code reader 22b, whereby information concerning the customer (below-mentioned campaign information and member information) is sent to the POS host device 21. Similarly, information concerning the customer inputted through a key input part 22c (below-mentioned campaign information and member information) is sent to the POS host device 21.

The portable telephone 30 has a processing part (serving as the processing device) 31, a sending and receiving part 32 for communicating with a base station of a portable telephone network (not shown) in accordance with the control of the processing part 31, a power supply part 33 for supplying electric power to the processing 31, a key input part 34 including dialing buttons, a display panel 35 for displaying various screens in accordance with the control of the processing part 31, a data storage part 36 to store data (HTML file, image file, etc.) sent from the Internet 100 via the portable telephone network (not shown), and a program storing part 37 where various programs each of which is to be read and executed by the processing part 31.

The program storing part 37 is a flash memory, which stores a WWW browser 37a, a mailer 37b that is a program to implement functions of editing, sending, and receiving e-mail, the below-mentioned identification information display program 37c, etc.

A user of this portable telephone 30 can talk with other user of the portable telephone 30 via the portable telephone network (not shown) in the figure by properly operating the key input part 34 thereof. Further, the user of this portable telephone 30 can edit, send, and receive e-mail by activating the mailer 37b through proper operation of the key input part 34, and can browse the home page presented on the Internet 100 by activating the WWW browser 37a.

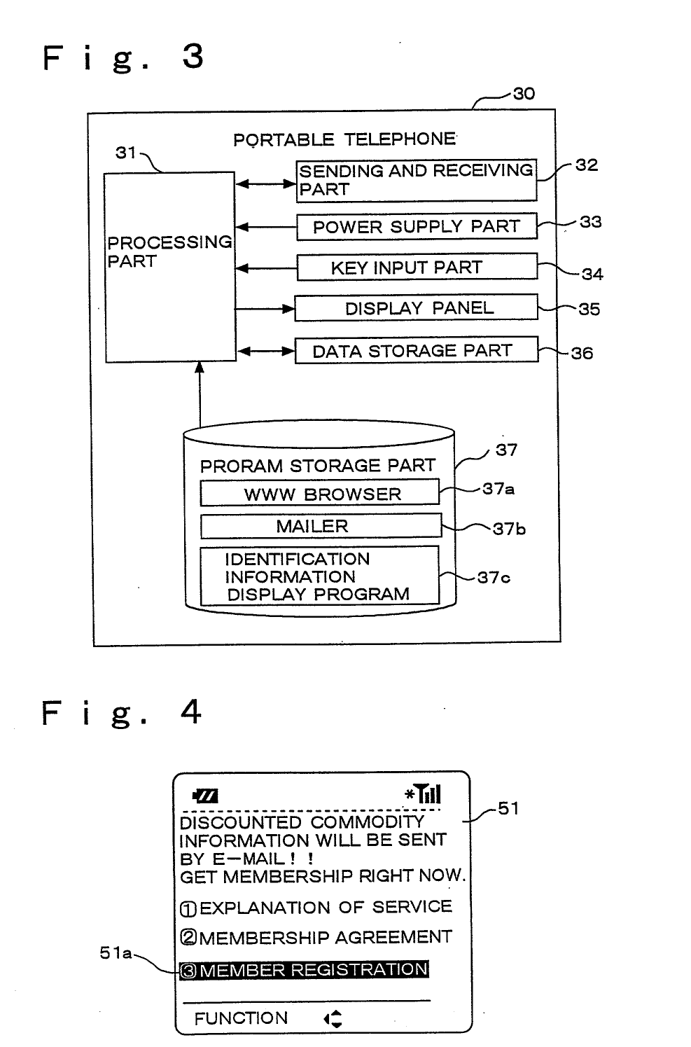

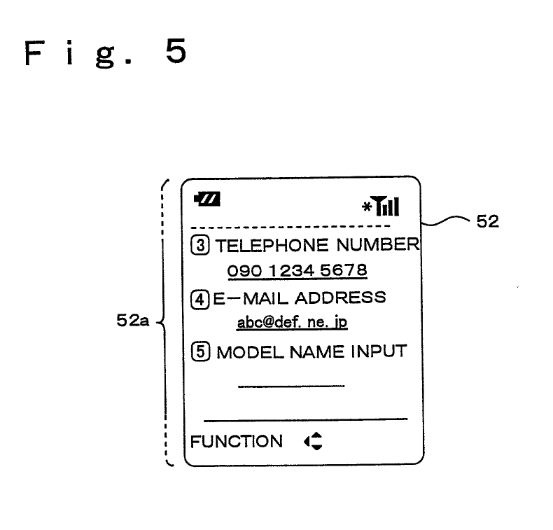

Hereinafter, referring to FIG. 4 through FIG. 26, the processing executed by the above-mentioned campaign system 1 will be described concretely. Here, for convenience' sake, a person who offers service of presenting the home page (Web page) containing various contents through the campaign execution apparatus 10 is referred to as “service provider A”, a person who acquires the commodity information of a commodity sold by himself or herself through the POS system 20 is referred to as “dealer B”, and a person who receives campaign mail sent through the campaign system 1 with the portable telephone 30 is referred to as “user C.”

Hereafter, the campaign system 1 will be explained assuming that a service provider A is entrusted with “management of the member information” and “agency for campaign advertisement on Web pages” by a dealer B. However, as will be described later, an advertiser who entrusts the campaign advertisement to the service provider A is not limited to a dealer B using a POS system 20.

The campaign system 1 according to this embodiment is initiated by an event that an advertisement of recruiting the members is published on a Web page that is distributed by the campaign server 11 of the campaign execution apparatus 10 based on a commission from of the dealer B.

<Contents of Member Information Sending Processing in a Portable Telephone>

When the processing part 31 of the portable telephone 30 operated by the user C accesses the campaign server 11 of the campaign execution apparatus 10 via the Internet 100 by activating the WWW browser 37a, HTML files and the image data of the Web page presented by the campaign server 11 are interpreted by the WWW browser 37a and a screen of the Web page is displayed on the display 35. Hereinafter, sending HTML file is written simply as “to send a screen.”

FIG. 4 shows a state where the member recruitment screen 51 which is one page of the various Web pages presented by the campaign server 11 is displayed on the display 35 of the portable telephone 30. In the member recruitment screen 51 shown in this FIG. 4, there are provided a plurality of areas where phrases of the advertisement for member recruitment and several choices including “member registration” (“explanation of service,” “member agreement (abstract),” etc.) were described.

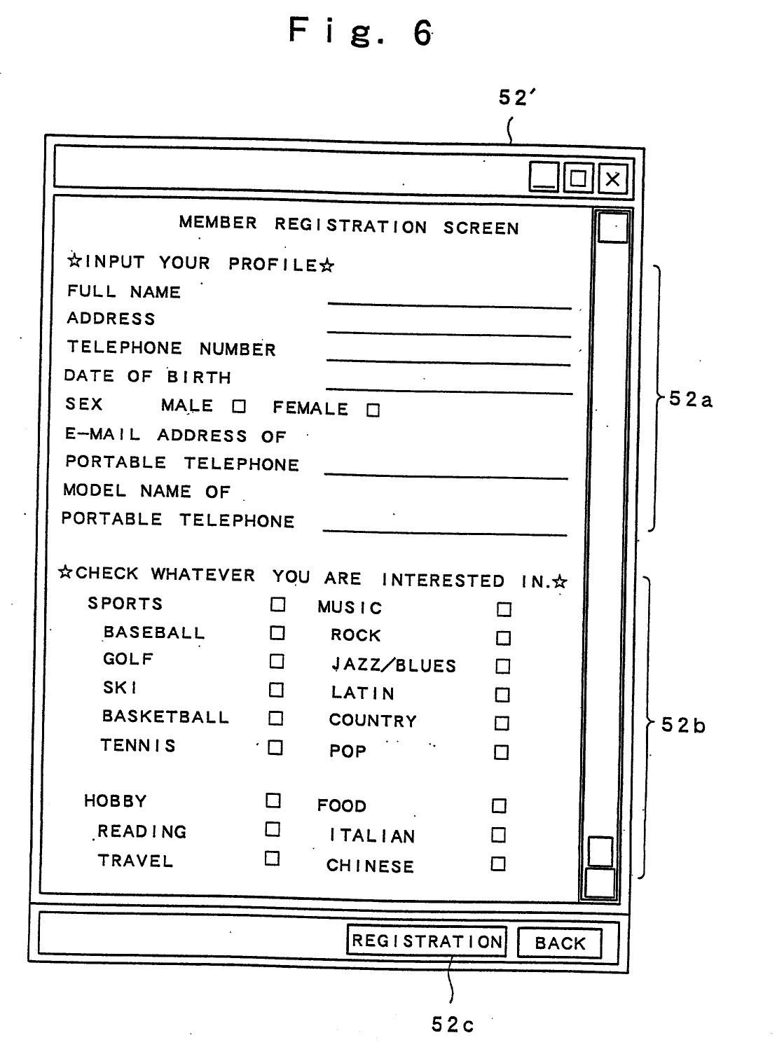

Then, if an area 51a indicated as “member registration” in the member recruitment screen 51 shown in FIG. 4 is selected by the user operating the key input part 34 (note that in the member recruitment screen 51, the area 51a indicating the “member registration” that was selected is displayed with black and white inverted), processing for displaying the member registration screen is conducted in the portable telephone 30 and the member registration screen 52 as shown in FIG. 5 is displayed on the display 35. However, FIG. 5 is an illustrative view where only a portion of the member registration screen 52 is displayed, because a display area of the display panel 35 of the portable telephone 30 is small, therefore the whole span of this member registration screen 52 is not displayed on this display panel 35 at a time, and actually the user is expected to scroll the screen to see the whole of the screen. Display contents in the case where the whole span of this member recruitment screen 52 is displayed on a display of a common computer is shown in FIG. 6. The member registration screen 52, 52′ shown in FIG. 5 and FIG. 6 comprises a profile input column 52a to be input with the private information of an user wishing to apply the member registration, a questionnaire input column 52b to be input with the preference information that defines fields where the person is interested, an area 52c indicated as “Registration” (in FIG. 6, this area being equivalent to the registration button) etc. Moreover, the profile input column 52a includes a plurality of areas into which full name, address, telephone number, date of birth and sex of the user C, e-mail address (serving as destination information) corresponding to the portable telephone 30 that the user C uses, and the model name of the portable telephone 30 are inputted, respectively. The questionnaire input column 52b includes a plurality of areas in which the choices consisting of classes (sports, music, . . . ) and subclasses (baseball, golf, . . . ) in various fields are described.

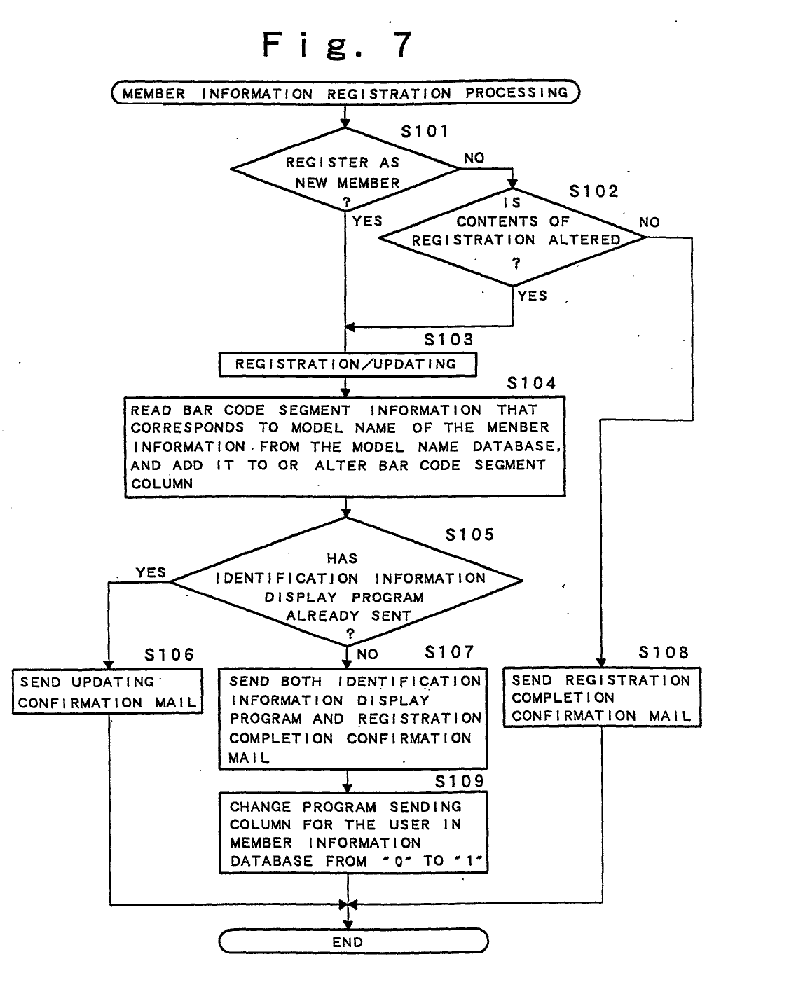

When, on the member registration screen 52 as shown in FIG. 5, the private information of the User C is inputted into the profile input column 52a and several areas are selected as answers to choices of the fields in the questionnaire input column 52b (in the member registration screen 52′ shown in FIG. 6, this selection being equivalent to inputting a check mark), and subsequently, an area indicated as the “Registration” is selected (in the member registration screen 52′ shown in FIG. 6, this selection being equivalent to clicking the area 52c indicated as the “Registration”), these pieces of information are sent to the campaign server 11 as the member information consisting of the private information and the preference information. Then, the campaign server 11 executes the member information registration processing. FIG. 7 is a flowchart indicating the contents of the processing.

<Contents of the Member Information Registration Processing in the Campaign Server>

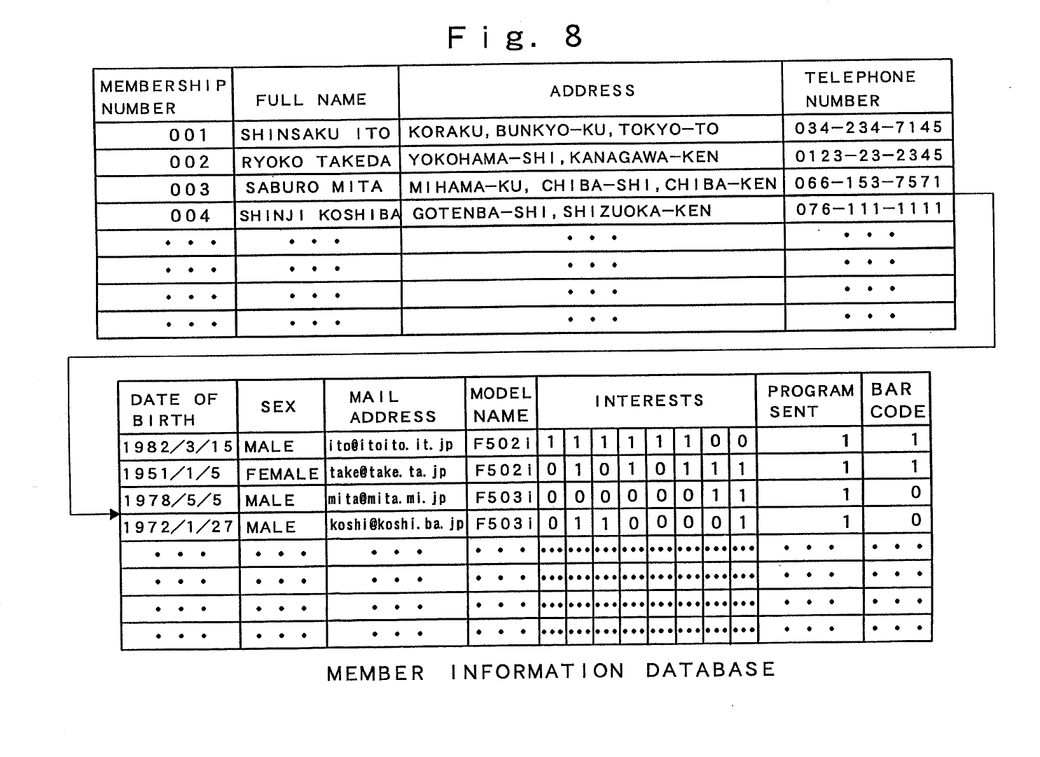

At first step S101, the campaign server 11 checks whether or not the user wishing to apply the registration is a person has already been registrated. More specifically, the campaign server 11 checks whether or not a part of the private information of the User C (i.e., full name, date of birth, sex) that has been inputted into the profile input column 52a of the received member registration screen 52 is retained in the member information database 14. FIG. 8 shows one example of the member information database 14.

As shown in this FIG. 8, in the member information database 14 stored are private information consisting of, for each registered member, a membership number uniquely given to the member (serving as the first identification information), the full name, address, telephone number, date of birth and sex of the member, the model name of the portable telephone 30 that is used by the user, and e-mail address corresponding to the portable telephone 30. Moreover, in this member information database 14, stored is the preference information that is defined according to the questionnaire results from the member (in FIG. 8, this being the “hobby and preference data”), for every member. Incidentally, the area to be stored with the preference information is divided into a plurality of columns (in FIG. 8, only eight columns being indicated) corresponding to respective choices in the questionnaire area 52b shown in FIG. 6. In each column, “1” is set when the corresponding choice was selected in the questionnaire area 52b (in other words, when the check box being checked), and “0” is set when the corresponding choice was not selected (in other words, when the check mark being removed from the check box). Moreover, in this member information database 14, prepared are a “program sending” column to record a flag indicating whether or not the below-mentioned identification information display program has been sent to the member (“0” is set when it has not been sent and “1” is set when it has already been sent) and a “bar code” column to record a flag indicating whether or not the portable telephone used by the member registrant is a model capable of displaying a bar code (“0” is set when it can display a bar codes, and “1” is set when it can not display a bar code). Incidentally, these pieces of information that have been registered for each member in the member information database 14 are called, as a whole, “member information.”

If the campaign server 11 judges that the part of the private information (full name, date of birth, and sex) is not retained in the member information database 14 at the step S101, the campaign server 11 adds the private information and the preference information of the said user C to the member information database 14 at step S103. At this time, the membership number whereby this user C is identified is additionally given to the member information of the user C that is to be added to the member information database 14.

On the other hand, if the campaign server 11 judges that the part of the private information is retained in the member information database 14 at step S101, the campaign server 11 checks whether or not remainder of the private information (address, telephone number, e-mail address, and model name) that has been inputted into the profile input column 52a of the received member registration screen 52 and the preference information that has been inputted into the questionnaire input column 52b agree with the member information of the user C that is retained in the member information database 14 at step 102.

If the remainder of the private information (address, telephone number, e-mail address, model name) and the preference information agree with the member information of the user C that is retained in the member information database 14, in other words, if it is judged that there is no alteration in the contents of registration at S102, the campaign server 11 sends e-mail to the effect that the user C has already been registered to the portable telephone 30 and ends the member information registration processing.

On the contrary, if it is judged that the remainder of the private information (address, telephone, e-mail address, and model name) and the preference information do not agree with the member information of the user C that is retained in the member information database 14, in other words, if it is judged that there is alteration (addition or deletion) in the contents of registration, the campaign server 11 alters the member information of the said user C that is retained in the member information database 14 at step S103.

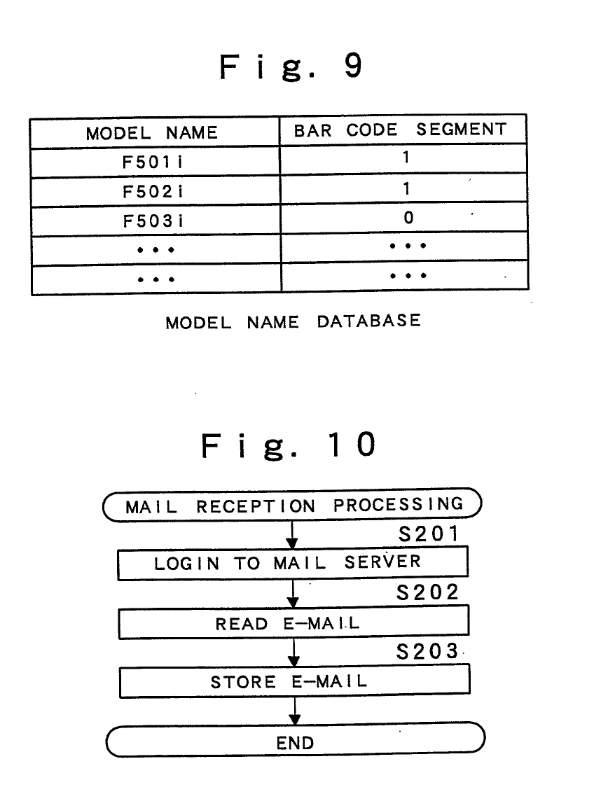

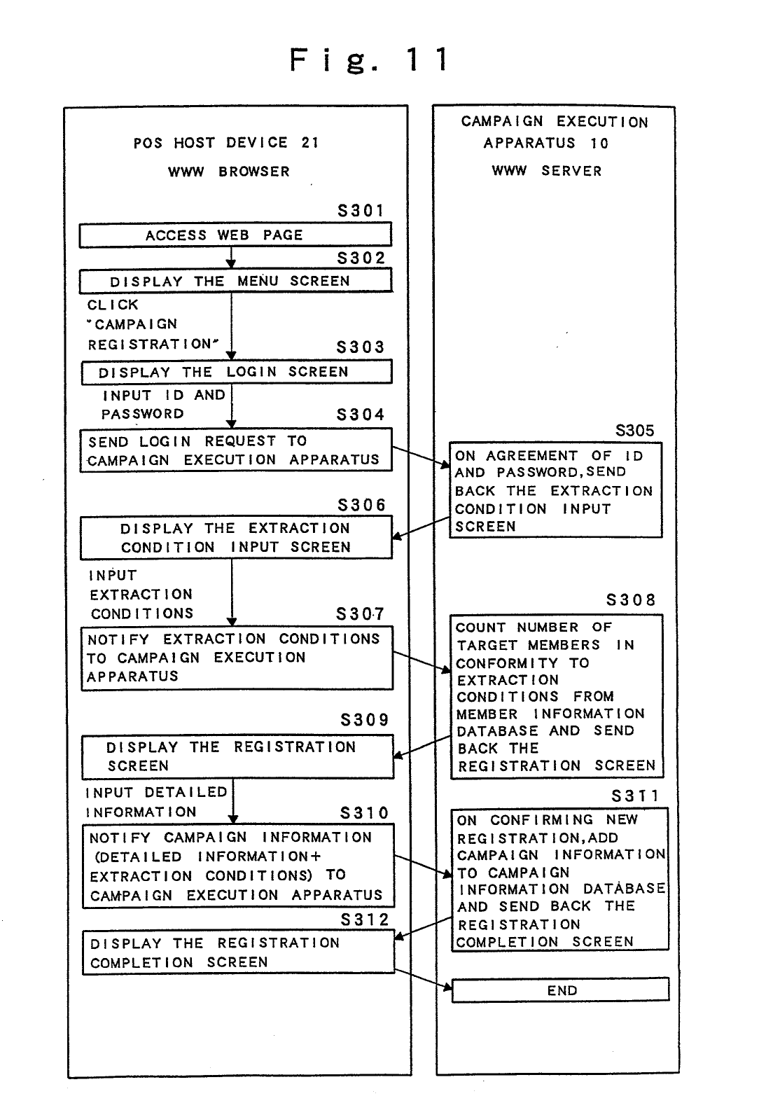

After the execution of step S103, the campaign server 11 reads the model name of the user C that is retained in the member information database 14, judges whether or not the portable telephone 35 that has the read model name can display a bar code, and records the judgment result in the “bar code” column of the member information data base 14 at step S104. More specifically, the campaign server 11 retrieves the model name data base 13 on the basis of the model name read from the member information data base 14. As shown in FIG. 9, in the model name database 13, each model name of the portable telephone 30 is related to the bar code segment that takes either “1” in the case where the portable telephone 30 having the model name is incapable of displaying a bar code or “0” in the case where it is capable of displaying a bar code. Then, the value of the bar code segment obtained as a result of retrieval is written (overwritten) in the “bar code” column for the said user C in the member information database 14.

At next step S105, the campaign server 11 checks whether or not the identification information display program, which will be described later, has been sent to the said user C. More specifically, the campaign server 11 checks whether the content of the “program sending” column for the said member in the member information database 14 is “1” indicating already-sent or “0” indicating not-yet-sent. Then, if the content of the “program sending” column for the said user C is “1,” at step S106 the campaign server 11 sends e-mail to the effect that the member information has been updated to an e-mail address corresponding to the portable telephone 30 of the said user C that has been stored in the member information database 14 and ends the member information registration processing.

On the contrary, if at step S105 it is judged that the content of the “program sending” column for the said user C is “0,” the campaign server 11 sends both e-mail to the effect that the member information has been registered and the below-mentioned identification information display program (that is, a class file of Java applet) to an e-mail address corresponding to the portable telephone 30 of the said user C at step S107 (this function being equivalent to the program sending part). At next step S109, the campaign server 11 changes the content of the “program sending” column for the said user C that is retained in the member information database 14 from “not-yet-sent (0)” to “already-sent (1).” Then, the campaign server 11 ends this member information registration processing.

In such a way as described above, in the campaign execution apparatus 10, the private information and the preference information of the user C who has the portable telephone 30 capable of using the Internet are accumulated in the member information database 14.

<Contest of the E-mail Reception Processing in the Portable Telephone>

In steps S106, S107, or S108 described above, when the campaign server 11 sends e-mail to the e-mail address corresponding to the portable telephone 30 of the user C, the full text of the sent e-mail is stored in a mail box of the mail server (not shown in the figure) for the portable telephones 30 and at the same time the full text or part of it is sent to the portable telephone 30. In the portable terminal network of a system configuration where part of the mail is sent, when the user operates the key input part 34 of the portable telephone 30, the mailer 37b is activated and the mail reception processing (this function being equivalent to the e-mail receiving part) is started. FIG. 10 is a flowchart indicating the contents of the mail reception processing.

The processing part 31 of the portable telephone 30 executes a login procedure to its own mail server not shown in the figure via the portable telephone network not shown in the figure, at step S201, reads a received mail that was addressed to itself and stored in a mail box provided in the mail server at next step S202, and stores the received mail in the data storage part 36 at next step S203.

Then, when a display instruction of the received mail is inputted into the portable telephone 30 by the user C operating the key input part 34, the processing part 31 of the portable telephone 30 conducts the processing for displaying the contents of the e-mail on the display 35, whereby the contents of the e-mail is displayed on the display 35 of the portable telephone 30.

Since, the contents of the e-mail sent from the campaign execution apparatus 10 is thus displayed on the display 35 of the portable telephone 30, in the case where the user C having already been registered as the member requests alteration of his/her member information, the user C can confirm a fact that his/her member information has been updated by means of the e-mail sent from the campaign execution apparatus 10 at step S106.

Further, in the case where the user C having already been registered as the member requests the registration of the member information of the same content as that already registered, the user C can know a fact that he/she has already been registered as the member by means of the e-mail sent from the campaign execution apparatus 10 at step S108.

Moreover, in the case where the user C newly requests the member registration, the user C can confirm a fact that the registration has been completed by means of the e-mail sent from the campaign execution apparatus 10 at step S107. More specifically, the portable telephone 30 receives the identification information display program 37c from the campaign execution apparatus 10 and stores the identification information display program 37c in a program storage part 37.

<Contents of a Procedure of the Campaign Information Registration of the Campaign Execution Apparatus and the POS Host Device>

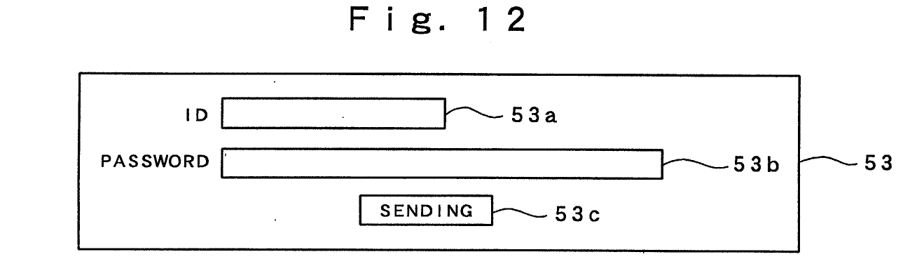

On the other hand, when it becomes necessary for the dealer B to promote a campaign for the members, the dealer B registers the campaign in the campaign execution apparatus 10 via the POS host device 21. FIG. 11 is a sequence diagram showing an operation procedure of the POS host device 21 and the campaign server 11 of the campaign execution apparatus 10 at that time.

When the POS host device 21 operated by an operator of the dealer B accesses the campaign server of the campaign execution apparatus 10 via the Internet by activating a WWW browser 21a (step S301), the HTML files and image data of a Web page presented by the campaign server 11 are interpreted by the WWW browser 21a, and the POS host device 21 conducts processing for displaying a menu screen not shown in the figure on a display thereof (step S302).

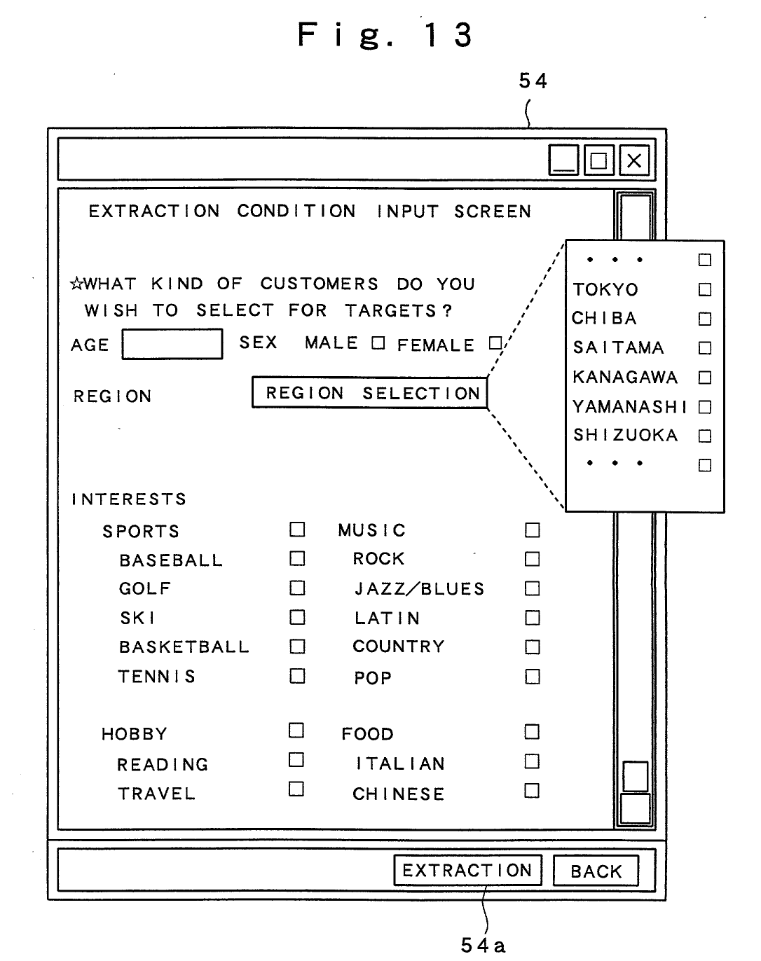

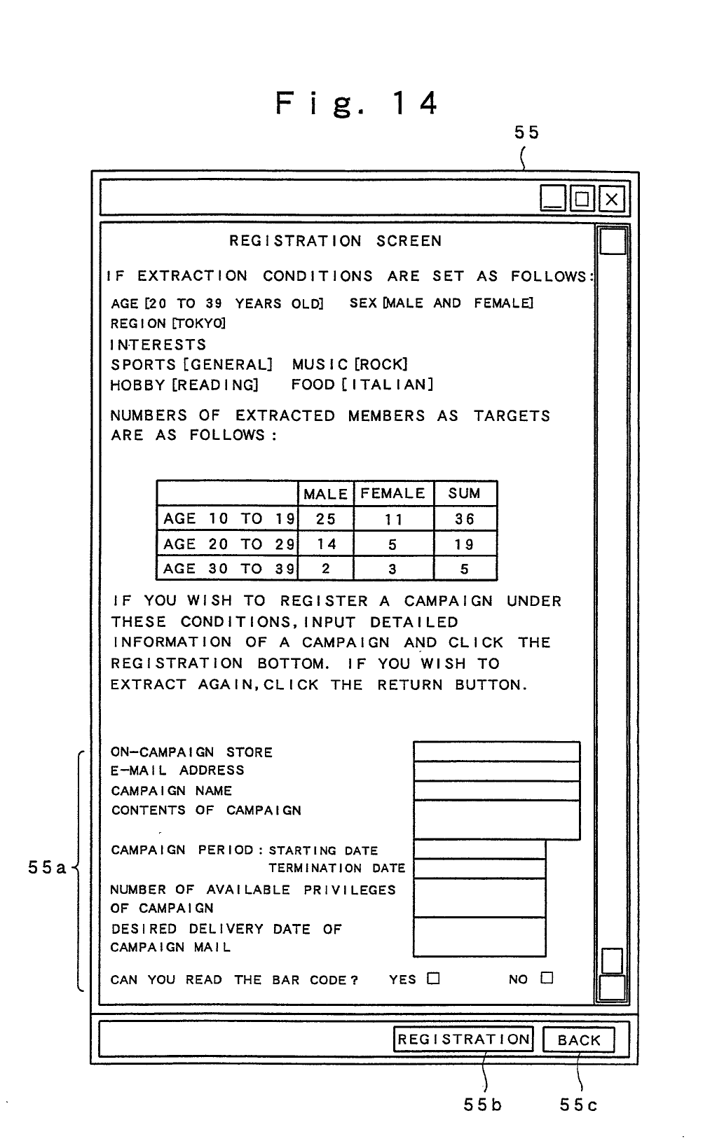

Then, when the operator of the dealer B operating the POS host device 21 selects “Campaign registration” on the menu screen displayed on the display, the POS host device 21 conducts the processing for displaying the login screen 53 as shown in FIG. 12, so that a login screen 53 having two text boxes 53a, 53b to be input with the ID and the password, respectively, is displayed on the display of the POS host device 21. These ID and password are the ones that have been given to the dealer B as for authorization purpose by the service provider A beforehand at the time the dealer B entrusts the service provider A with its business. If the operator of the dealer B inputs the ID and the password in the text boxes 53a, 53b of the login screen 53 as shown in FIG. 12 and subsequently clicks a sending button 53c, the campaign server 11 confirms that a combination of the ID and the password contained in a login request coincides with the one that has been registered beforehand and sends the extraction condition input screen 54 as shown in FIG. 13 to the POS host device 21 that submitted the login request (step S305). On the contrary, if the combination of the ID and the password contained in the login request does not coincident with the not the one that has been registered beforehand, the campaign server 11 sends back a screen to the effect that to the POS host device 21.

Then, the POS host device 21 that received the extraction condition input screen 54 conducts the processing for displaying the extraction condition input screen (step S306) and, on the display of the POS host device 21, the extraction condition input screen 54 as shown in FIG. 13 is displayed. The extraction condition input screen 54 shown in this FIG. 13 comprises an area to be input with the conditions of campaign targets to be extracted from the member information database 14 and an area 54a indicated as “Extraction.” Incidentally, the area to be input with the extraction conditions on the extraction condition input screen 54 includes an area where choices enumerated in the questionnaire input column 52b on the member registration screen 52′ shown in FIG. 6 are to be selected as the extraction conditions as well as an area where “age,” “sex,” and “region” are set as the extraction conditions, respectively. Incidentally, the above-mentioned “region” denotes a residential area of the member, and if any region is selected as an extraction condition, the member information of the members whose addresses are in the selected region is extracted.

When the operator of the dealer B inputs the extraction conditions regarding “age,” “sex,” “region,” and/or “Hobby and Preference” for extracting the campaign target members in the extraction condition input screen 54 as shown in FIG. 13 and subsequently clicks the area indicated as “Extraction,” the inputted extraction conditions are sent to the campaign server 11 (step S307). Then, the campaign server 11 extracts the member information that corresponds to the target members of the campaign from the member information database 14 based on the extraction conditions. More specifically, the campaign server 11 extracts the member information that satisfies the age and the sex specified as an extraction conditions, that includes an address in the region specified as an extraction condition, and that “1” is set for each of one or a plurality of choices that is specified as extraction condition from the member information database 14. Then, the campaign server 11 counts the number of pieces of member information extracted, namely, the number of the campaign target members.

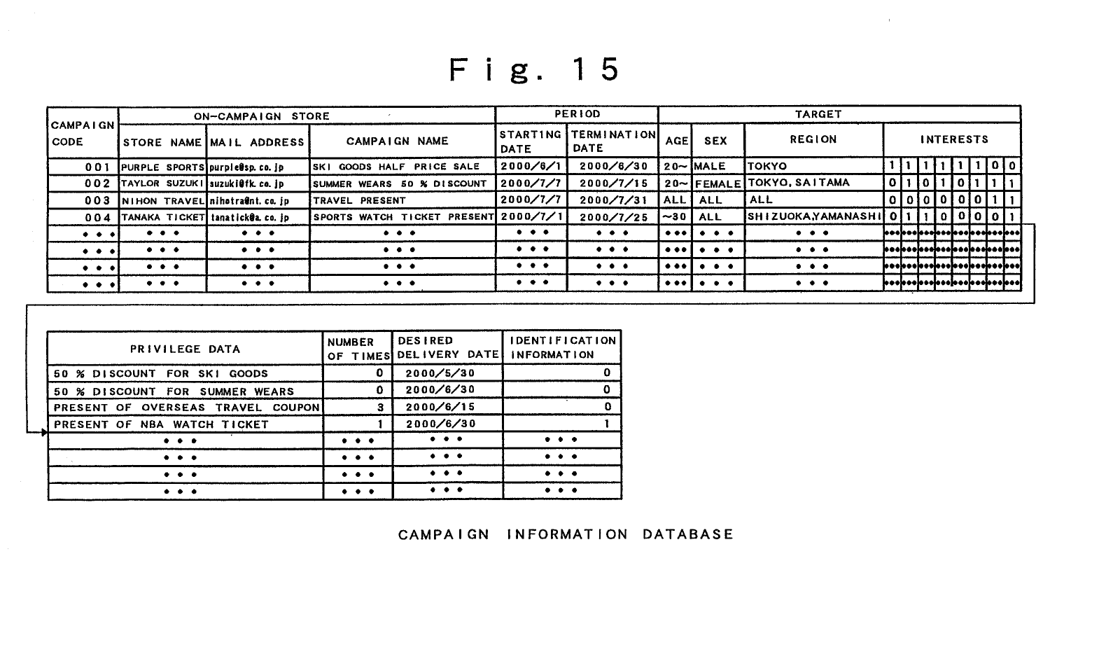

Subsequently, the campaign server 11 sends back the registration screen that contains the specified extraction conditions and the number of the campaign target members under the extraction conditions to the POS host device 21 (step S308). Then, the POS host device 21 conducts the processing for displaying the registration screen, so that the registration screen 55 as shown in FIG. 14 is displayed on the display of the POS host device 21(step S309). As shown in this FIG. 14, the registration screen 55 contains the extraction conditions that have been sent to the campaign server 11 at step S307 and the number of the campaign target members in conformity to the extraction conditions, and includes a detailed information input column 55a to be input with detailed information about the campaign. This detailed information input column 55a includes a plurality of text boxes to which “on-campaign store name,” “e-mail address,” “campaign name,” “content (privilege) of campaign,” “starting date and termination date of campaign period,” “number of available privileges,” and “desired delivery date of campaign mail” are inputted, respectively, and further includes a check box to be input with whether or not the POS system of the on-campaign store whose name is set in “on-campaign store name” text box can read a bar code. Incidentally, in the text box to be input with “number of available privileges,” a numeral indicating a number of times the member can enjoy the campaign service during the campaign period is written, and if the number of time is unlimited, “0” is written therein.

When the operator of the dealer B inputs the detailed information about the campaign in the detailed information input column 55a of the registration screen 55 and subsequently clicks the area 55b indicated as “Registration,” the campaign information consisting of the extraction conditions and the detailed information (information inputted into the detailed information input column 55a) are sent to the campaign server 11 (step S310). Incidentally, if the operator of the dealer B wishes to alter the extraction conditions to execute re-extraction after seeing the number of the campaign target members that was counted and indicated in the registration screen 55, the operator is expected to click the area 55c indicated as “Return” and then the extraction condition input screen 54 is re-displayed in the POS host device 21. Consequently, the operator can input the extraction conditions again to make the campaign server 11 count the number of the campaign target members again.

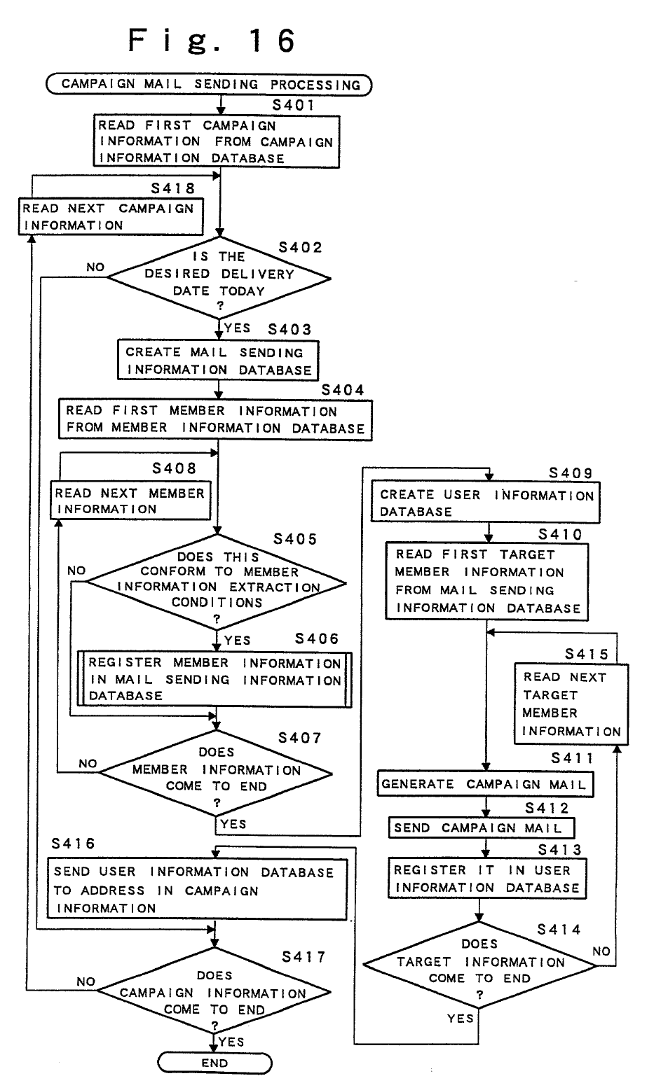

On receiving the campaign information, the campaign server 11 checks whether or not “on-campaign store name,” “campaign name,” and “campaign period” are the ones that have already been registered. Then, if these have not been registered, the campaign server 11 adds this campaign information to the campaign information database and sends back a registration completion screen not shown in the figure to the POS host device 21 (step S311). FIG. 15 is the table showing a data structure of the campaign information database 15. As shown in this FIG. 15, the campaign information database 15 has, for each campaign that is registered, a plurality of columns to register the contents of the above-mentioned campaign information, each column for each item, and a column to record the campaign number (equivalent to the second identification information) that is uniquely given.

For example, “privilege data” column shown in FIG. 15 records “contents of campaign” in the campaign information and “number of times” column records “number of available privileges” in the campaign information. Moreover, in “identification information” column, if the POS system of a store that holds the campaign based on the campaign information can read a bar code, “0” is set, whereas if the POS system of the store that holds the campaign cannot read a bar code, “1” is set. Incidentally, if the campaign server 11 judges that “on-campaign store name,” “campaign name,” and “campaign period” are already retained in the campaign information database 15, it sends back a screen to the effect that the campaign information has already been registered to the POS host device 21.

On receiving the registration completion screen, the POS host device 21 conducts the processing for displaying this registration completion screen on the display (step S312).

Thus, the campaign execution apparatus 10 accumulates the campaign information sent from the dealer B that decided to hold the campaign for the members in the campaign information database 15.

<Contents of the Campaign Mail Sending Processing in the Campaign Execution Apparatus>

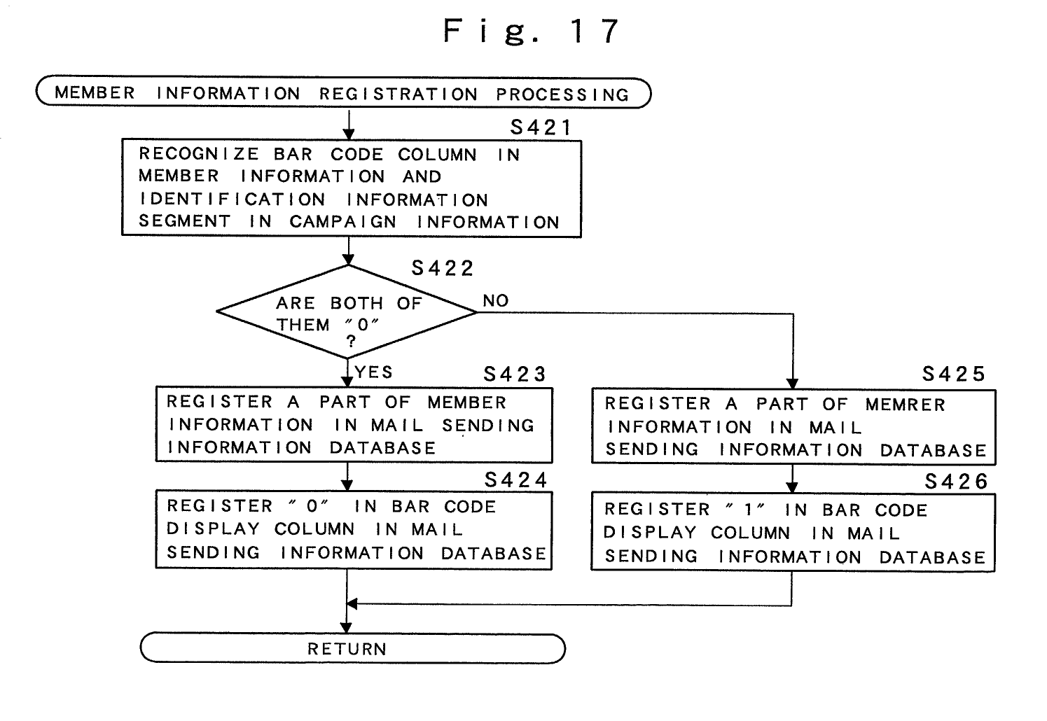

The campaign server 11 sends e-mail for informing the campaign to the target members of each campaign, once a day, based on each campaign information retained in the campaign information database 15. FIG. 16 is a flowchart indicating the campaign mail sending processing that the campaign server 11 executes.

At first step S401, the campaign server 11 reads first campaign information retained in the campaign information database 15 as objective campaign information, and advances the processing to step S402.

At step S402, the campaign server 11 checks whether or not the desired delivery date contained in the objective campaign information is that day of processing. Then, if the desired delivery date is not that day of processing, the campaign server 11 advances the processing to step S417, whereas, if the desired delivery date is that day of the processing, it advances the processing to step S403.

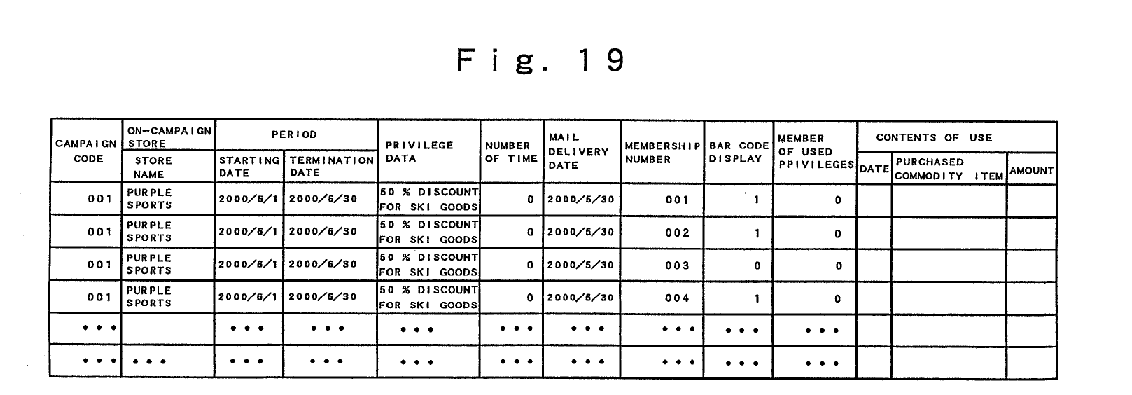

At step S403, the campaign server 11 creates a mail sending information database 16 based on the to-be-processed campaign information. As shown in FIG. 18, the mail sending information database 16 has entries, for each member of the mail destination, to store contents of “campaign code,” “on-campaign store name,” “campaign name,” “starting date of period,” “termination date of period,” “privilege data,” “number of times,” and “desired delivery date” in the objective campaign information and contents of “membership number,” “full name,” “mail address,” and “bar code” contained in the member information, as one set of target member information. However, at the time when this step S403 is executed, each entry of the mail sending information database 16 is a blank space.

At next step S404, the campaign server 11 reads first member information retained in the member information database 14 as objective member information and advances the processing to step S405.

At step S405, the campaign server 11 checks whether or not the objective member information conforms to the extraction conditions in the objective campaign information. Then, if the objective member information does not conform to the extraction conditions, the campaign server 11 advances the processing to step S407, whereas, if the objective member information conforms to the extraction conditions, it advances the processing to step S406.

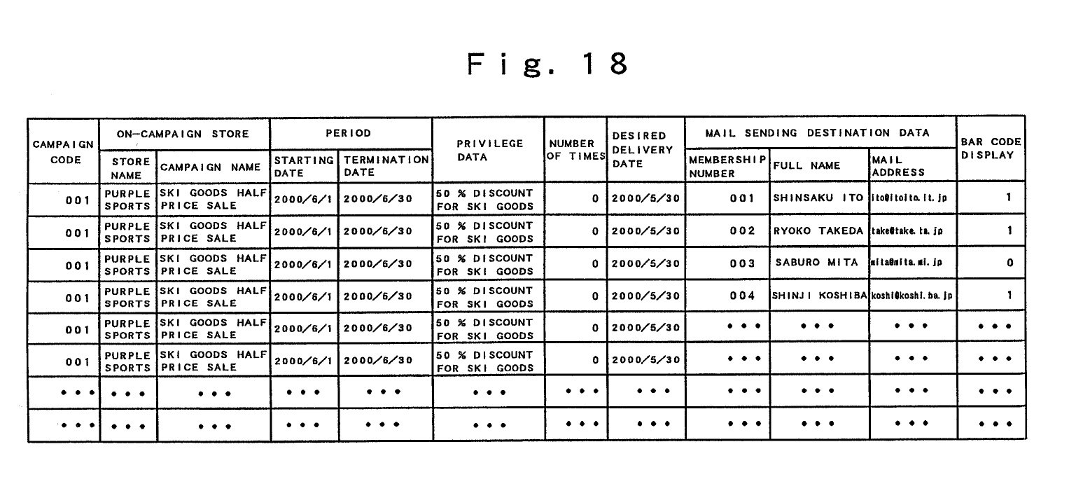

At step S406, the campaign server 11 executes the processing for registering the objective member information in the mail sending information database 16 created at step S403. FIG. 17 is the flowchart indicating a subroutine of the member information registration processing executed at this step S406. At first step S421 when entering this subroutine, the campaign server 11 reads the contents of the “bar code” column in the objective member information and the contents of the “identification information” column in the objective campaign information. At next step S422, the campaign server 11 checks whether or not the contents of the “bar code” column and of the “identification information” column that were read at step S421 are both “0.” Then, if the both are “0,” in other words is, if the portable telephone 30 corresponding to the objective member information can display a bar code and the POS system 20 corresponding to the objective campaign information can read a bar code, the campaign server 11, at step S423, registers a part of the objective member information (member number, full name, and e-mail address) in an empty entry in the mail sending information database 16, and at next step S424 registers “0” in the “bar code display” column of the same entry. On the contrary, if both or either of the contents of the “bar code” column and of the “identification information” column is “1”, the campaign server 11, at step S425, registers the part of the member information (member number, full name, and e-mail address) in an empty entry in the mail sending information database 16, and at next step S426 registers “1” in the “bar code display” column of the same entry. In any case, subsequently, the campaign server 11 ends this subroutine of the member information addition processing, and returns the processing to the main routine of FIG. 16.

In the main routine of FIG. 16, at next step S407 the campaign server 11 checks whether or not unread member information remains in the member information database 14. Then, if the unread member information remains, at step S408 the campaign server 11 reads the next member information from the member information database 14 as new objective member information, and returns the processing to step S405. On the contrary, if the unread member information does not remain, the campaign server 11 advances the processing to step S409.

At step S409, the campaign server 11 creates the user information database 17 based on the objective campaign information. This user information database 17 has, as shown in FIG. 19, a plurality of columns to store the contents of “campaign code,” “on-campaign store name,” “starting date of period,” “termination date of period,” “privilege data,” “number of times,” “membership number,” and “bar code” contained in each target member information stored in the mail sending information database 16, respectively, a “mail delivery date” column to store a mail delivery date, a “number of used privileges” column to store the number of times the member has actually used the campaign, and a plurality of columns to store the contents of the use of the capmpaign. Note that at the time when step S409 is executed, each column of this user information database 17 is an empty column.

At next step S410, the campaign server 11 reads first target member information retained in the mail sending information database 16.

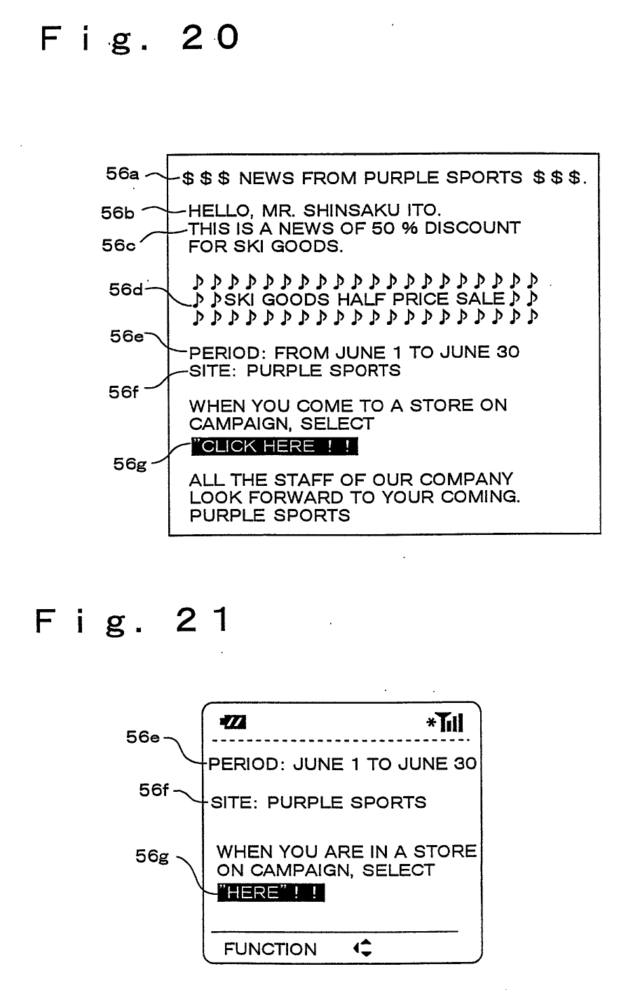

At next step S411, the campaign server 11 generates campaign mail based on the target member information read at step S410 (or the target member information read at step S415) (this function being equivalent to the e-mail generation part). This campaign mail is described in the form of MINE and a document composition of the text is as shown in FIG. 20. More specifically, as indicated by reference numerals 56a-56f in FIG. 20, in the text of the campaign mail, “on-campaign store name,” “full name” of the target member, “privilege data,” and “period (from starting date to termination date)” that are contained in the target member information are put into writing according to a prescribed context. Further, in this text, a phrase that goes “Click Here!” is described together with a tag for making this phrase be displayed as an event area in the form of a button. In this tag, the contents of the identification information (one that is formed by combining the “campaign code” and the “membership number” of the target member both of which are contained in the target member information according to a specific logic) and of the “bar code display” are embedded as comment sentences that will not appear in the screen when this campaign mail is displayed on the display. Further, in the header of this campaign mail, the “mail address” contained in the target member information was set as the destination, and the mail address of the campaign execution apparatus 10 was set as the sender, respectively.

At next step S412, the campaign server 11 sends the campaign mail generated at step S411 to the unillustrated mail server in the portable telephone network by using the mailer 12.

At next step S413, the campaign server 11 registers the contents of the target information in the user information database 17.

At next step S414, the campaign server 11 checks whether or not unread target member information remains in the mail sending information database 16. Then, if the unread target member information remains, the campaign server 11 reads next target member information from the mail sending information database 16 at step S415 and returns the processing to step S411. On the contrary, if the unread target member information does not remain in the mail sending information database 16, the campaign server 11 advances the processing to step S416.

At step S416, the campaign server 11 duplicates the user information database 17 and sends it to the “mail address” of on-campaign store contained in the objective campaign information (this function being equivalent to the notification part). Subsequently, the campaign server 11 advances the processing to step S417.

At step S417, the campaign server 11 checks whether or not unread campaign information remains in the campaign information database 15. Then, if the unread campaign information remains, the campaign server 11 reads next campaign information from the campaign information database 15 at step S418 and returns the processing to step S402. On the contrary, if the unread campaign information does not remain, the campaign server 11 ends this campaign mail sending processing.

Thus, the campaign execution apparatus 10 sends the campaign mail to the user C who uses the portable telephone 30 and at the same time sends the user information database 17 to the dealer B who has the POS system 20, and subsequently the processing for storing the user information database 17 is conducted in the POS host device 21 of the POS system 20 (this function being equivalent to the receiving part) and the mail reception processing shown in FIG. 10 is conducted in the portable telephone 30 and the campaign mail is stored in the data storage part 36.

<Contents of the Identification Information Display Processing in the Portable Telephone>

When the display instruction for the received mail is inputted into the portable telephone 30 by the user C operating the key input part 34, the processing part 31 of the portable telephone 30 conducts the processing for displaying the campaign mail on the display panel 35. FIG. 21 shows a display mode in the case where the campaign mail is displayed on the display panel 35 of the portable telephone 30. Note that when the campaign mail 35 is displayed on the display panel 35 of the portable telephone 30, the text of the campaign mail is displayed partially in a scrollable state. FIG. 21 shows an example where a period 56e, a site 56f, and an event area 56g are displayed.

When this event area 56g is selected by the user C operating the key input part 34 (in FIG. 21, the event area 56g being displayed with black and white inverted), the processing part 31 of the portable telephone 30 activates the identification information display program 37c that has been sent from the campaign execution apparatus 10 in accordance with the member information registration processing shown in FIG. 7 and subsequently stored in the program storage part 37 in accordance with the mail reception processing shown in FIG. 10, and conducts the processing for displaying the identification information.

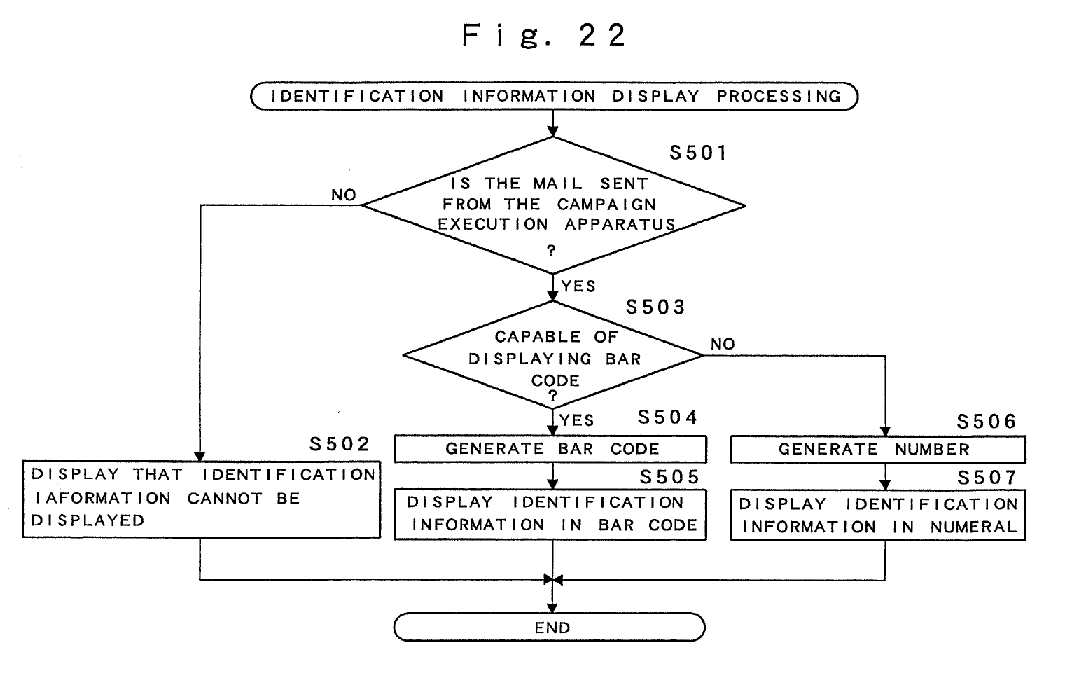

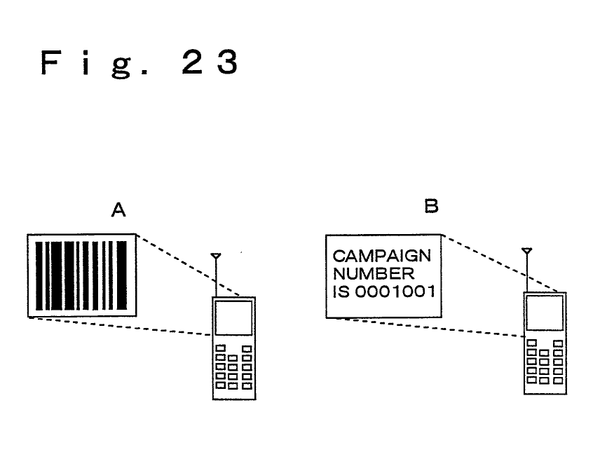

FIG. 22 is a flowchart indicating the contents of the identification information display processing.

At first step S501, the processing part 31 of the portable telephone 30 checks whether or not the campaign mail is sent from the campaign execution apparatus 10. More specifically, since the e-mail address of the campaign execution apparatus 10 was recorded in the identification information display program 37c, the processing part 31 that executes this identification information display program 37c checks whether or not the email address of the sender recorded in the mail header of the campaign mail agrees with the e-mail address recorded in the identification information display program 37c.

Then, if the processing part 31 judges that the received campaign mail is not e-mail sent from the campaign execution apparatus 10 (in other words, if both mail addresses do not agree with each other), the processing part 31 displays, on the display panel 35, to the effect that the identification information cannot be displayed at step S502 and ends this identification information display processing.

On the contrary, if the received campaign mail is judged to be sent from the campaign execution apparatus 10 (in other words, if both e-mail addresses agree with each other), at step S503, the processing part 31 checks whether or not the display panel 35 can display a bar code and whether or not the POS system 20 of the on-campaign store can read a bar code. More specifically, the portable telephone 30 checks whether the contents of the “bar code display” embedded in the tag for making the event area 56g of the campaign mail displayed is “0” or “1.” Then, if the display panel 35 can display the bar code and the POS system 20 of the on-campaign store can read the bar code (in other words, if the contents of “bar code display” is “0”), the processing part 31 generates a bar code as shown in FIG. 23A according to the identification information embedded in the tag at step S504, displays this bar code on the display panel 35 at next step S505 and ends this identification information display processing.

On the contrary, if the display panel 35 cannot display a bar code or if the POS system of the on-campaign store cannot read a bar code (in other words, if the contents of “bar code display” is “1”), the processing part 31 generates a numeral as shown in FIG. 23B according to the identification information embedded in the tag at step S506, displays this numeral together with words and phrases for the campaign at next step S507, and ends this identification information display processing.

<Contents of the User Information Storage Processing in the POS Host Device>

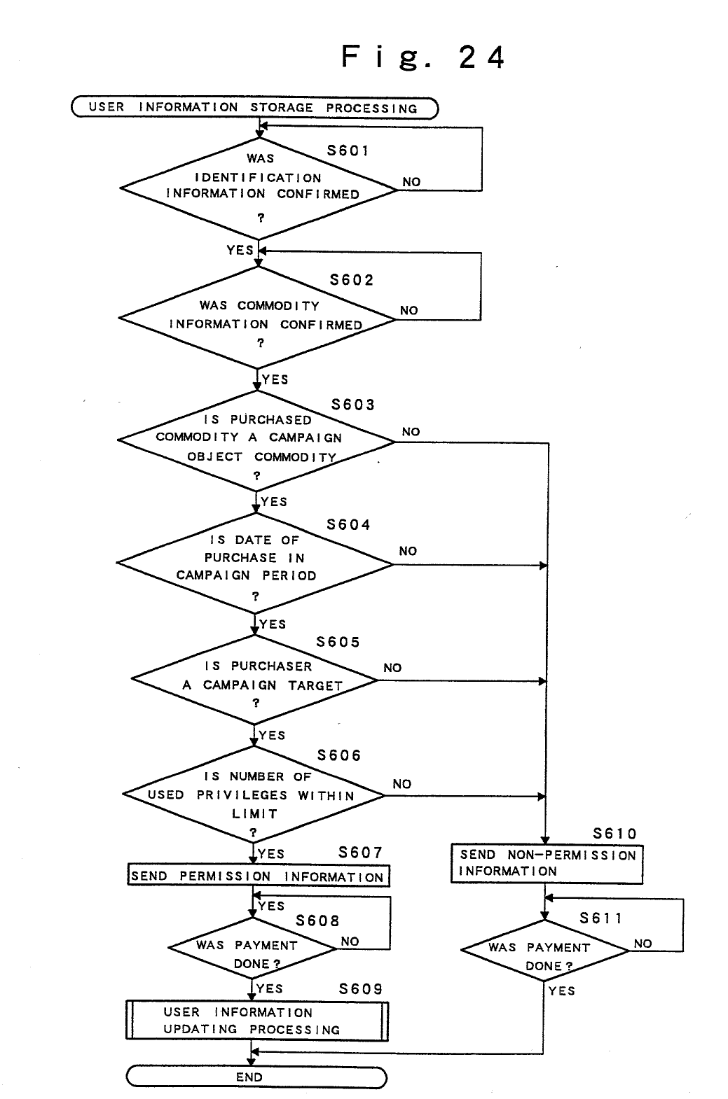

The identification information display processing as described above is executed when the user C purchases a campaign object commodity at a store of the dealer B where the campaign is being conducted (on-campaign store where the POS terminal is installed). Then, when the identification information displayed on the display panel 35 as the bar code or a numeral according to this identification information display processing is inputted to the POS terminal 22 together with the commodity information of the purchased campaign object commodity via the bar code reader 22b or the key input part 22c of the POS terminal 22, these pieces of information are sent together to the POS host device 21. Then, when the CPU 211 of the POS host device 21 receives these identification information and commodity information, the CPU 21 executes the user information storage processing (this function being equivalent to the collating part) for adding the commodity information of the purchased campaign object commodity and the membership number of the user C to the user information database 21e(17) that has been sent beforehand from the campaign execution apparatus 10 and stored in the storage medium 210 according to the commodity information management program 21b. FIG. 24 is a flowchart indicating the contents of this user information storage processing.

At first step S601, the CPU 211 of the POS terminal 22 recognizes the identification information received from the POS terminal 22 (this function being equivalent to the decoder).

At next step S602, the CPU 211 recognizes the commodity information received from the POS terminal 22.

At next step S603, the CPU 211 checks whether or not the commodity information recognized at step S602 is of the campaign object commodity. Then, if the CPU 211 judges that the commodity information is not of the campaign object commodity, the CPU 211 advances the processing to step S610. On the contrary, if the CPU 211 judges that the commodity information is of the campaign object commodity, the CPU advances the processing to step S604.

At step S604, the CPU 211 checks whether or not the campaign for the commodity corresponding to the commodity information recognized at step S602 is being conducted. More specifically, the CPU 211 checks whether or not the date when the commodity was purchased is between the “starting date” and the “termination date” of the “period” recorded in the user information database 21c. Then, if the CPU 211 judges that the campaign is not being conducted, the CPU 211 advances the processing to step S610. On the contrary, if the CPU 211 judges that the campaign is being conducted, the CPU 211 advances the processing to step S605.

At step S605, the CPU 211 checks whether or not the identification information recognized at step S601 is of the campaign target member. More specifically, the CPU 211 checks whether or not the campaign code contained in the identification information recognized at step S601 agrees with the campaign code recorded in the user information database 21e and also whether or not the membership number contained in the identification information exists in the user information database 21e. Then, if the CPU 211 judges that the identification information is not of the campaign target member, the CPU 211 advances the processing to step S610. On the contrary, if the CPU 211 judges that the identification information is of the campaign target member, the CPU 211 advances the processing to step S606.

At step S606, the CPU 211 checks whether or not the numeral in the “number of used privileges” column corresponding to the membership number in the identification information in the user information database 21e reaches the limit value that was set in the “number of times” column. Then, if the numeral in the “number of used privileges” column reaches the limit value that was set in the “number of times” column, the CPU 211 advances the processing to step S610. On the contrary, if the numeral in the “number of used privileges” column does not reach the limit value that was set in the “number of times” column, the CPU 211 advances the processing to step S607.

At step S607, the CPU 211 sends permission information including the contents of the “privilege data” column in the user information database 21e to the POS terminal 22 which has sent the identification information and the commodity information. In the POS terminal 22 that received this permission information, processing according to the contents of the “privilege data” is executed. For example, if the contents of the “privilege data” is discount of a commodity price, the price after being discounted is automatically calculated, and the amount of payment reflects the discounted price. If the contents of the “privilege data” is a present, the content thereof is displayed on the display 22d, therefore the cashier can hand the present to the user C. In any case, when the amount calculated by the processing part 22a of the POS terminal 22 is paid, the cashier inputs information indicating completion of payment via the key input part 22c. Then, this information is sent from the POS terminal 22 to the POS host device 21.

At next step S608, the CPU 211 of the POS host device 21 awaits the information indicating completion of payment from the POS terminal 22, and on receiving this information, the CPU 211 advances the processing to step S609.

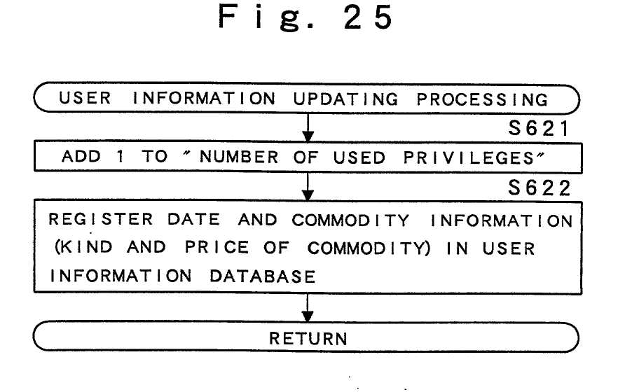

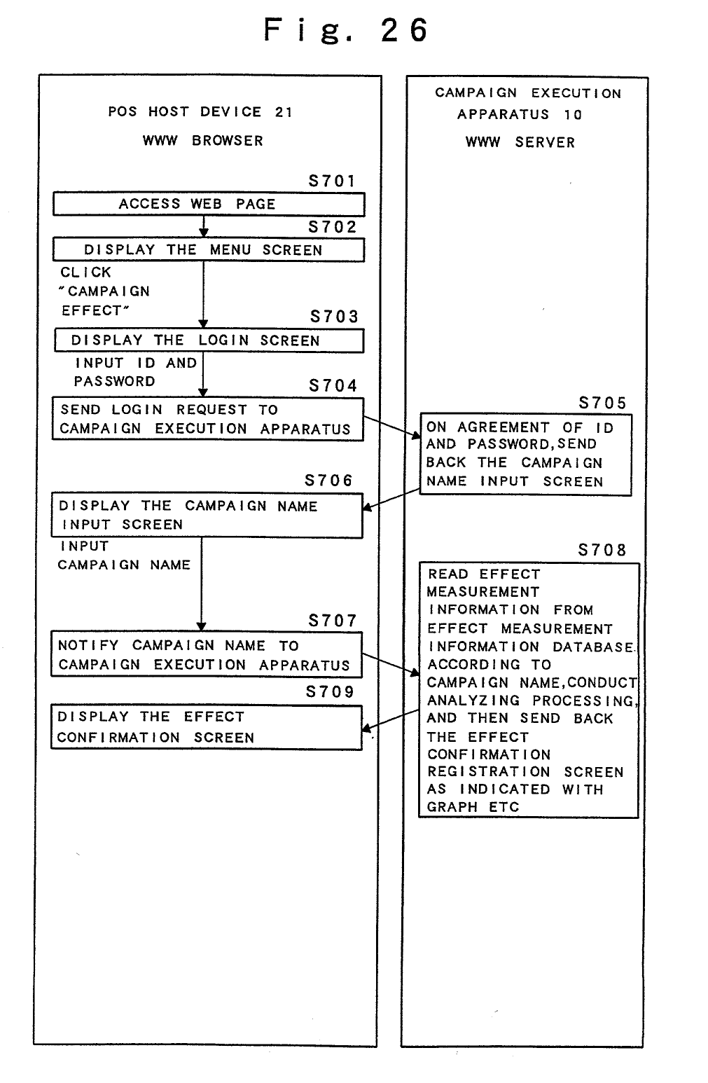

At step S609, the CPU 211 executes the user information updating processing. FIG. 25 is a flowchart indicating a subroutine of this user information updating processing. At first step S621 after entering this subroutine, the CPU 211 increments the “number of used privileges” corresponding for the member information in the identification information by one in the user information database 21e. At next step S622, the CPU 211 registers the name and the price of the commodity indicated by the commodity information and date of purchase of this commodity, in a way of being relating to the member information in the identification information, in the user information database 21c. Subsequently, the CPU 211 ends this subroutine of the user information updating processing, and returns the processing to the main routine of FIG. 24.

In the main routine to which the processing was returned, the CPU 211 completes step S609 and subsequently ends this user information storage processing.

On the other hand, at step S610 the CPU 211 sends non-permission information including a reason why “NO” is judged at one of steps S603 to S606 to the POS terminal 22 which has sent the identification information and the commodity information.

In the POS terminal 22 that received the non-permission information, the reason why the privilege is not permitted is displayed on the display 22d, as required, and the payment is done as usual. Then, when the amount is paid, information indicating completion of the payment is sent to the POS host device 21.

At next step S611, the CPU 211 of the POS host device 21 awaits the information indicating completion of payment from the POS terminal 22 and, on receiving this information, ends this user information storage processing.

Thus, in the user information database 21e accumulated is the identification information of the user C having purchased the campaign object commodities during the campaign period.

<Contents of a Procedure of Confirmation of a Campaign Effect with the Campaign Execution Apparatus and the POS Host Device>

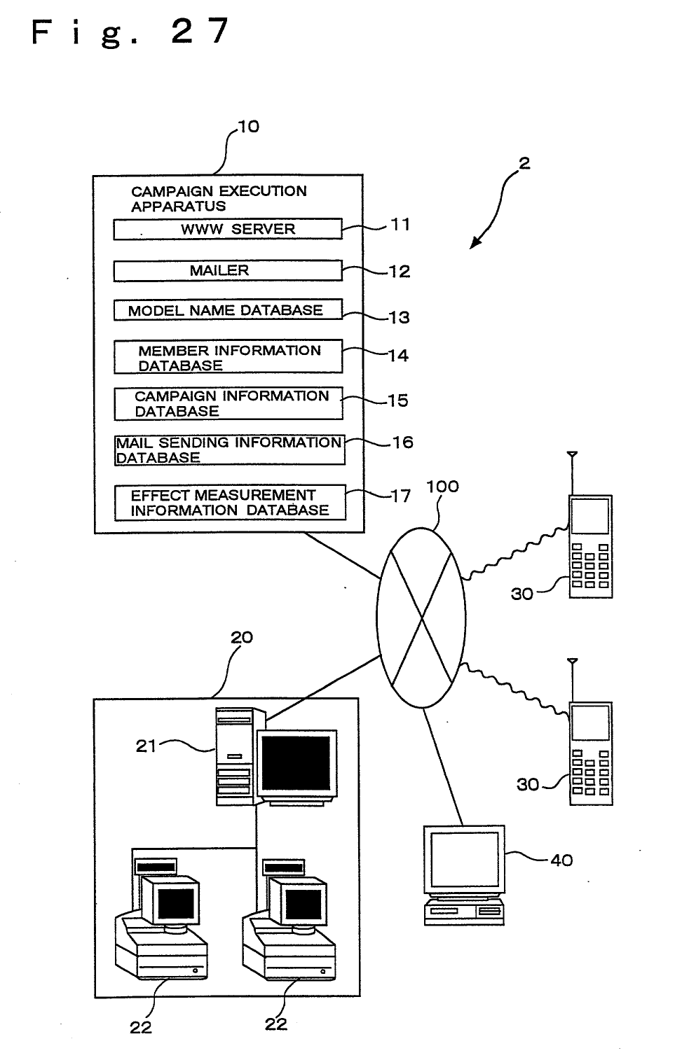

If the operator of the dealer B inputs a direction of sending start of the user information database at the time the period of the campaign has expired or at an arbitrary time, the CPU 211 of the POS host device 21 sends the whole data in the user information database 21e to the campaign execution apparatus 10 as the user information (this function being equivalent to the notification part). The user information that was sent from the POS host device 21 to the campaign execution apparatus 10 is merged with the original user information database 17 that has been left in the campaign execution apparatus 10 to achieve accumulation of the data. At an arbitrary time after expiration of the campaign, the dealer B accesses the campaign execution apparatus 10 from the POS host device 21 in order to confirm the effect of the campaign based on the user information accumulated in the user information database 17 through the campaign. FIG. 26 is a sequence diagram showing the operation procedure of the POS host device 21 and the campaign execution apparatus 10 at that time.

When the POS host device 21 operated by the dealer B accesses the campaign server 11 of the campaign execution apparatus 10 via the Internet by activating the WWW browser 21a (step S701), the HTML files and image data of the Web page presented by the campaign server 11 are interpreted by the WWW browser 21a and unillustrated menu screen is displayed on the display (step S702).

When the operator of the dealer B operating the POS host device 21 clicks an area indicated as “effect of campaign,” on the unillustrated menu screen that is displayed on the display, a login screen 53 as shown in FIG. 10 is displayed on the display of the POS host device 21 (step S703).

When the operator of the dealer B inputs the ID and the pass word into text boxes in the login screen 53 as shown in FIG. 10, respectively, and subsequently clicks a send button 53c (step S704), the campaign execution apparatus 10 confirms that a combination of the ID and the pass word contained in the login request is what was previously registered and sends back unillustrated campaign name input screen in the figure to the POS host device that has submitted the login request (step S705).

Then, the campaign name input screen is displayed on the display of the POS host device 21 that received the campaign name input screen (step S706).

Subsequently, when the operator of the dealer B inputs the campaign name in the campaign name input screen displayed on the display of the POS host device 21 and then clicks a send button (step S707), the campaign execution apparatus 10 reads whole data from the user information database 17 that corresponds to the campaign name. Then, after the whole data that has been read was analyzed (this function being equivalent to analyzing means), a screen where the effect of the campaign is displayed as a graph etc. is sent back to the POS host device 21 (step S708).

The operator of the dealer B can verify whether or not the effect of the campaign has been achieved based on the displayed contents of this screen, and can make use of the verification results for future sales promotion.

Further, the service provider A having the campaign execution apparatus 10 can accumulate the member information of the dealer B and manage it as long as business-tie up with the dealer B continues. Then, when there arises the registration of campaign information by the dealer B, the campaign execution apparatus 10 extracts target members from the member information database 14 in conformity to the contents of the registered campaign information and sends campaign mail to the portable telephones 30 of these target members N.

According to the campaign system 1 having a configuration described in the foregoing, an advertiser of the campaign can do direct publicity to the user C having the portable telephone 30 by sending campaign mail directly, so that the user C is impelled to actually come to a store where the POS system is installed.

Further, since the dealer B can accumulate more detailed private information together with the commodity information, the dealer B can narrow down the purchasers when a campaign for sales promotion is conducted at shopfront, and can specify potential customers who have purchased the commodities at storefront in the past to send them direct mails etc.

On the other hand, the user C using the portable telephone 30 can receive only campaign mail concerning the commodities screened carefully so as to fit his/her preference simply by answering the questionnaire when registering the membership.

The campaign mail is less abandoned without being read, and consequently it becomes more effective as publicity for the side sending the campaign mail.

Example of use of the campaign system

Hereafter, four examples of operation modes of this campaign system 1 will be shown.

Example of use 1

In the explanation of the campaign system 1 described above, it is assumed that the dealer B having the POS system 20 entrusted the service provider A with “management of member information” and “agency for campaign advertisement business on the Web page.” In this case, it is possible that the dealer B (e.g., proprietor of a drug store, a restaurant, a shop of fishing tackle, a shop of daily necessaries, etc.) offers discount service to the user C for the commodities that the dealer B deals with, and presents novelty goods, free gift, travel coupon, store order, etc. to the user C when purchasing the commodity.

Example of use 2

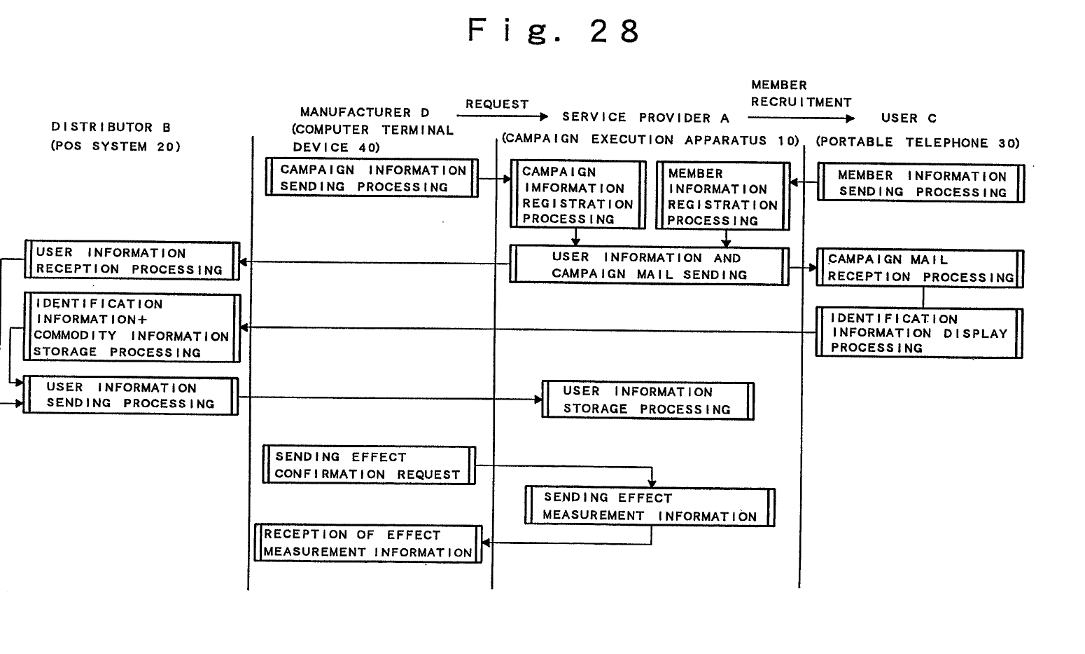

There is a case where a company who entrusts the service provider A with “management of member information” and “agency for campaign advertisement business on the Web page” is not a dealer B having the POS system 20 but a manufacturer or importer of the commodities. A network configuration of the campaign system 2 of this case is shown in FIG. 27, and also a diagram of relations of the dealer B, the user C, and a manufacturer D with respect to the service provider A is shown in FIG. 28.

In this case, for example, the following scheme is conceivable. The manufacturer D (e.g., eye glass manufacturer, drinking water manufacturer, etc.) who has entrusted campaign advertisement business registers the campaign information to the campaign execution apparatus 10 of the service provider A via a computer terminal of its company, whereby the manufacturer D makes the campaign execution apparatus 10 send campaign mail to the portable telephones 30 of the campaign target members extracted from registered members of its company, and makes the campaign execution apparatus 10 promote campaign service only for its company's commodities (e.g., discount sale service and present service) so that at the campaign target members may use the portable telephone 30 at storefront of the dealer B who deals with its commodities as well as other company's commodities (e.g., eye glass shop, department store, drugstore, liquor store, etc.).

As shown in this FIG. 28, compared to the case of example of use 1, processing that the dealer B conducts for the service provider A is only user information reception processing, identification information and commodity information storage processing, and user information sending processing, whereas other processing is executed by the manufacturer D on its computer terminal 40. Therefore, to the computer terminal possessed by the manufacturer D, effect measurement information that has been acquired by the POS system possessed by the dealer B is sent from the campaign execution apparatus 10 possessed by the service provider A.

Example of use 3

In the case where the dealer B having the above-mentioned POS system 20 does not entrust the service provider A with “management of member information” and “agency for campaign advertisement business on the Web page,” there is a further different form. For example, in the case where a company that entrusts the service provider A with agency for campaign advertisement business is a travel agent E, the contents of the campaign may be set in such a way that the user C can receive offering of services only at several limited stores/shops located at travel destinations (e.g., an accommodation, a souvenir store, an office of rent-a-car company, etc.).

Example of use 4

Further, there is a case where a company who entrusts the service provider A with “management of member information” and “agency for campaign advertisement business on the Web page” is not a single company of the dealer B but a plurality of retail stores. In this case, the service provider A creates the member information database 14 that is common for these plural retail stores in the campaign execution apparatus 10.

By this scheme, the service provide A can recruit a majority of retail stores that use this common member information database 14, and at the same time the registered members retained in this member information database can receive offering of a variety of services from a plurality of retail stores.

<Variations of the Campaign System>

Incidentally, in the above-mentioned campaign system 1, at step S413 where the campaign execution apparatus 10 executes the campaign mail sending processing (FIG. 16), the identification information consisting of the campaign code and the membership number is attached to the text of the campaign mail 56 as a comment statement that is not displayed on a display panel 35 of the portable telephone. However, a numeral generated from this identification information may be described in the text of the campaign mail 56 in the form of text so as to be displayed on 15. the display panel 35 of the portable telephone.

In this case, in the portable telephone 30 having received this campaign mail, a numeral based on the identification information is displayed at a position of the event area 56g in the text of the campaign mail shown in FIG. 21. Then, the user C who saw the numeral displayed on the display panel 35 can allow a cashier of the POS terminal 22 to input the identification information into the key input part 22c without making the portable telephone 30 execute the identification information display processing (FIG. 22). Further, portable information terminals that have a radio communication function and a WEB browsing function, such as a PDA and a mobile computer, may be used in stead of the portable telephone 30.

As described in the foregoing, according to the campaign system of the present invention, publicity can be given directly to the user of the portable information terminal so as to be impelled to actually come to the store where the information input terminal such as the POS system is installed. Further, the campaign system can accumulate not only the commodity information but also the user's exact private information, the user's preference information, and the user's past record of purchase information.

Although only a few embodiments of this invention have been described in detail above, those skilled in the art will readily appreciate that many modifications are possible in the preferred embodiments without departing from the novel teachings and advantages of this invention. Accordingly, all such modifications are intended to be included within the scope of this invention as defined by the following claims.

What is claimed is:

1. A campaign system where e-mail that contains first identification information corresponding to a previously-registered member and second identification information assigned to a specific campaign is sent from a campaign execution apparatus to a portable information terminal of said member, and a user of said portable information terminal is confirmed to be entitled to said campaign by a process where said identification information displayed on the portable information terminal having received the e-mail is inputted into an information input device,
said campaign execution apparatus comprising:
a first storage that stores said first identification information and destination information concerning a plurality of members;
a second storage that stores said second identification information assigned to any one of the campaigns;
an e-mail generation part for generating said e-mail containing said first identification information and said second identification information that were extracted from said first storage and said second storage, respectively, according to predetermined conditions; and
an e-mail sending part for sending the e-mail generated by the e-mail generation part to a destination indicated by said destination information corresponding to said first identification information that is contained in said e-mail,
said portable information terminal comprising:
an e-mail receiving part for receiving said e-mail; and
a display panel for displaying both pieces of said identification information that are contained in the e-mail received by said e-mail receiving part, and
said information input device comprising:
an input part into which said both pieces of identification information are inputted.

2. A campaign system according to claim 1,
said information input device further comprising:
a storage that stores said first identification information and said second identification information in advance; and
a collating part for collating whether or not said identification information inputted via said input part agrees with the identification information stored in said storage.

3. A campaign system according to claim 2,
said campaign execution apparatus further comprising:
a notification part for notifying said first identification information and said second identification information that were extracted from said first storage and said second storage, respectively, according to said predetermined conditions to said information input device, and
said information input device further comprising:
a receiving part for receiving said first identification information and said second identification information that were notified by said campaign execution apparatus and for writing these pieces of identification information into said storage.

4. A campaign system according to claim 4,
said information input device further comprising:
a notification part for notifying a collation result to said campaign execution apparatus when said collating part obtains a collation result that said both pieces of identification information inputted via said input part agree with said first identification information and said second identification information both stored in said storage, and
said campaign execution apparatus further comprising:
a third storage for storing said collation result notified by said information input device.

5. A campaign system according to claim 4, wherein said third storage stores said collation result so as to be related to member's private information corresponding to said first identification information.

6. A campaign system according to claim 5, said campaign execution apparatus further comprising analyzing part for analyzing information stored in said third storage.

7. A campaign system according to claim 1,
said portable information terminal further comprising:
a storage medium for storing a program; and
a processing device for executing the program stored in the storage medium,
said campaign execution apparatus further comprising:
a program sending part for sending a program for making the processing device of said portable information terminal display a bar code according to said first identification information and said second identification information on said display panel to said portable information terminal, and
said information input device further comprising:
a bar code reader for reading said bar code displayed on the display panel of said portable information terminal; and
a decoder for restoring said identification information based on the data obtained by this bar code reader reading said bar code.

8. A campaign execution apparatus which sends e-mail containing first identification information corresponding to a previously-registered member and second identification information assigned to a specific campaign for said member, comprising:
a first storage that retains said first identification information and destination information concerning a plurality of members;
a second storage that retains said second identification information assigned to any one of the campaigns;
an e-mail generation part for generating e-mail containing said first identification information and said second identification information that were extracted from said first storage and said second storage, respectively, according to predetermined conditions; and
an e-mail sending part for sending the e-mail generated by the e-mail generation part to a destination indicated by said destination information corresponding to said first identification information that is contained in said e-mail.

9. A computer-readable medium storing a program that makes a computer equipped with a communication device wherewith it can establish connection with the network connecting to portable information terminals:
generate a first storage that retains first identification information and destination information concerning a plurality of members;
generate a second storage that retains second identification information assigned to any one of the campaigns;
extract said first identification information and said destination information from said first storage according to predetermined conditions;
extract said second identification information from said second storage according to predetermined conditions;
generate e-mail containing these extracted first identification information and second identification information; and
send the generated e-mail to a destination indicated by said destination information via said communication device.

10. A method of promoting a campaign where e-mail that contains first identification information corresponding to a previously-registered member and second identification information assigned to a specific campaign is sent from a campaign execution apparatus to a portable information terminal of said member, and a user of said portable information terminal is confirmed to be entitled to said campaign through a process where said identification information displayed in the portable information terminal having received this e-mail is inputted into an information input device, said method comprising:
a first step of said campaign execution apparatus retaining said first identification information and destination information concerning a plurality of members and said second identification information assigned to any one of the campaigns;
a second step of said campaign execution apparatus generating an e-mail containing said first identification information and said second identification information that were extracted according to predetermined conditions;
a third step of said campaign execution apparatus sending the e-mail to a destination indicated by said destination information corresponding to said first identification information that is contained in the e-mail;
a fourth step of said portable information terminal receiving the e-mail containing said first identification information and said second identification information; and
a fifth step of said portable information terminal displaying both pieces of identification information that is contained in the e-mail.
